(19) United States
(12) Patent Application Publication
(10) Pub. No.: US 2025/0200036 A1
(43) Pub. Date: Jun. 19, 2025

(54) Whole-Query Optimization Using Program Synthesis

(71) Applicants: REGENTS OF THE UNIVERSITY OF MICHIGAN, Ann Arbor, MI (US); Simon Fraser University Technology Licensing Office, Burnaby (CA)

(72) Inventors: Barzan Mozafari, Ann Arbor, MI (US); Xinyu Wang, Ann Arbor, MI (US); Rui Dong, Ann Arbor, MI (US); Jie Liu, Ann Arbor, MI (US); Pinhan Zhao, Ann Arbor, MI (US); Yuxuan Zhu, Ann Arbor, MI (US); Yang He, Burnaby (CA); Yuepeng Wang, Burnaby (CA)

(21) Appl. No.: 18/977,185

(22) Filed: Dec. 11, 2024

Related U.S. Application Data
(60) Provisional application No. 63/609,551, filed on Dec. 13, 2023.

(51) Int. Cl. G06F 16/2453

(52) U.S. Cl. CPC G06F 16/24537; G06F 16/24545

(57) ABSTRACT

Methods and systems for performing a query search to rewrite queries are provided. The method may comprise: receiving an input database query to perform a first database operation, wherein the first database operation occurs within a first period of time; analyzing the input database query to determine a set of one or more query segments of the input database query representative of the first database operation; generating a plurality of candidate output database queries based at least on the one or more query segments; and determining at least one confirmed output database query of the plurality of candidate output database queries, wherein the at least one confirmed output database query, when implemented by a computing device, causes the computing device to perform a second database operation equivalent to the first database operation within a second period of time shorter than or equal to the first period of time.

### CROSS-REFERENCE TO RELATED APPLICATIONS

This application claims priority to and the benefit of the filing date of provisional U.S. Patent Application No. 63/609,551 entitled “WHOLE-QUERY OPTIMIZATION USING PROGRAM SYNTHESIS,” filed on Dec. 13, 2023. The entire contents of the provisional application are hereby expressly incorporated herein by reference.

### GOVERNMENT LICENSE RIGHTS

This invention was made with government support under 2210832, 2123654, and 2236233 by the National Science Foundation. The government has certain rights in the invention.

### FIELD OF THE DISCLOSURE

The present disclosure relates generally to techniques for generating and rewriting input database queries and, more particularly, to techniques for generating and rewriting such queries using synthesis techniques.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Poorly-written database queries cause a variety of problems when interacting with databases. A query may be generated automatically by software or written manually, and a poorly-written query may originate via either technique. In particular, poorly-written queries may cause longer runtimes, inefficient use of resources, and inaccurate or incomplete determinations. For sufficiently large databases and/or sufficiently complex queries, such inefficiencies may cause significant loss or waste of time, resources, energy, etc.

Current attempts to optimize database queries rely on rule-based query rewriting techniques. Rule-based techniques utilize rules crafted by experts and/or by tools, and such techniques are therefore limited in effectiveness. For example, rule-based techniques hinge on the quality and quantity of the rules provided. Curating a large collection of high-quality rules is a very tedious, error-prone and time-consuming process that requires deep expertise. Moreover, such techniques are fundamentally limited to situations in which the input query matches one of the patterns captured by the rules. Put another way, rule-based techniques miss optimization opportunities when a query follows a new pattern not anticipated by the rules in question.

There is a need for techniques that can be used to systematically and automatically rewrite queries without relying on rules that may fail to capture the full range of potential input queries. This will allow for optimization of database queries and improved operations of database search algorithms and/or techniques.

### SUMMARY OF THE INVENTION

The present techniques include methods and systems for performing a query search to rewrite queries. The method may comprise: receiving an input database query to perform a first database operation, wherein the first database operation occurs within a first period of time; analyzing the input database query to determine a set of one or more query segments of the input database query representative of the first database operation; generating a plurality of candidate output database queries based at least on the one or more query segments; and determining at least one confirmed output database query of the plurality of candidate output database queries, wherein the at least one confirmed output database query, when implemented by a computing device, causes the computing device to perform a second database operation equivalent to the first database operation within a second period of time shorter than or equal to the first period of time.

In an example, an system for performing a query search to rewrite queries comprises: one or more processors; a memory associated with the one or more processors and storing instructions that, when executed, cause the one or more processors to: receive an input database query to perform a first database operation, wherein the first database operation occurs within a first period of time; analyze the input database query to determine a set of one or more query segments of the input database query representative of the first database operation; generate a plurality of candidate output database queries based at least on the one or more query segments; and determine at least one confirmed output database query of the plurality of candidate output database queries, wherein the at least one confirmed output database query, when implemented by a computing device, causes the computing device to perform a second database operation equivalent to the first database operation within a second period of time shorter than or equal to the first period of time.

### BRIEF DESCRIPTION OF THE DRAWINGS

The figures described below depict various aspects of the system and methods disclosed herein. It should be understood that each figure depicts an example of aspects of the present systems and methods.

FIG. 1A is an example block diagram of a system configured to implemented methods for rewriting a query using synthesis techniques, as described herein.

FIGS. 1B and 1C are example block diagrams of an equivalence checker and programmed rules, configured to be implemented in the system of FIG. 1A.

FIGS. 2A-2D illustrate example queries and/or query optimizations as received and/or performed by a system such as the system of FIG. 1A.

FIG. 2E illustrates an example process for performing a testing and/or verification of a generated output in an example similar to those illustrated in and/or described with regard to FIGS. 2A-2D.

FIGS. 3A and 3B illustrate sets of example bar graphs depicting query coverage and latency reduction for various example database platforms.

FIGS. 4A-4C illustrate sets of example bar graphs depicting a percentage of benchmarks checked as equivalent for various example database platforms.

FIG. 5 illustrates a flowchart depicting an exemplary method for analyzing an input database query, generating an output database query using synthesis techniques, and testing and verifying the output database queries, implemented in the system of FIG. 1.

### DETAILED DESCRIPTION

Although the following text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

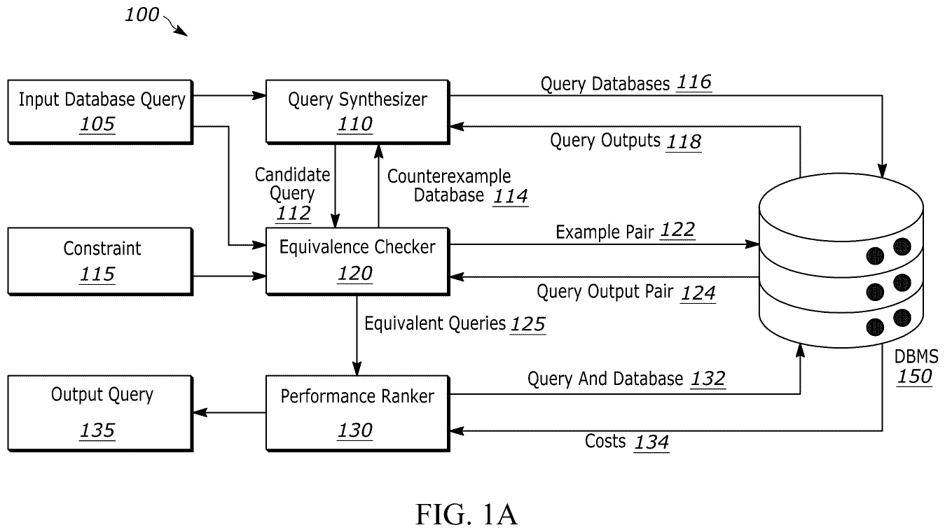

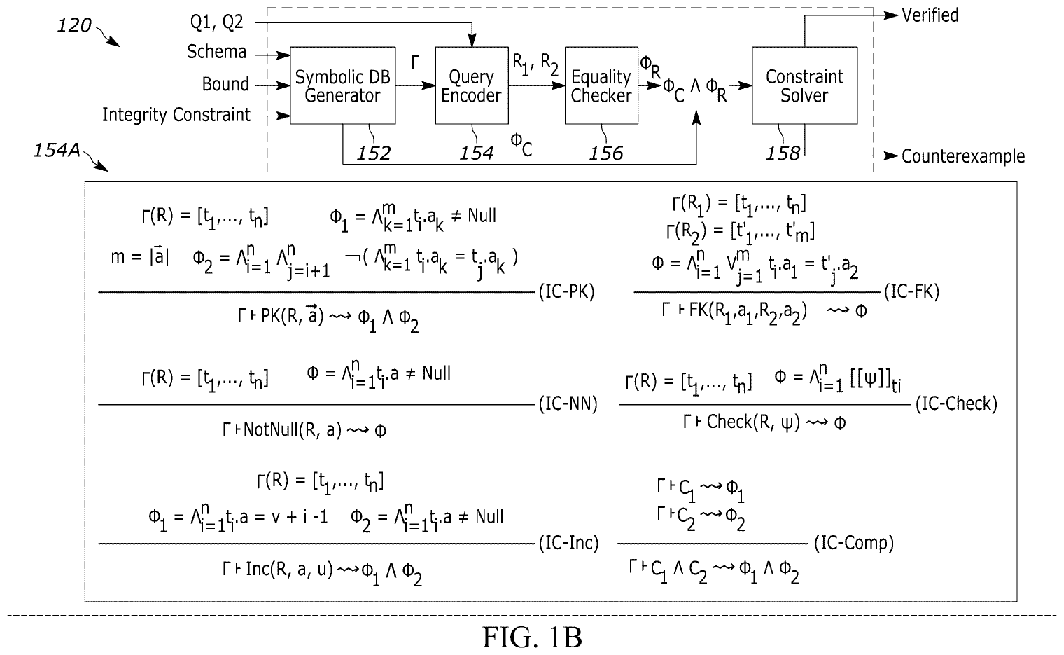

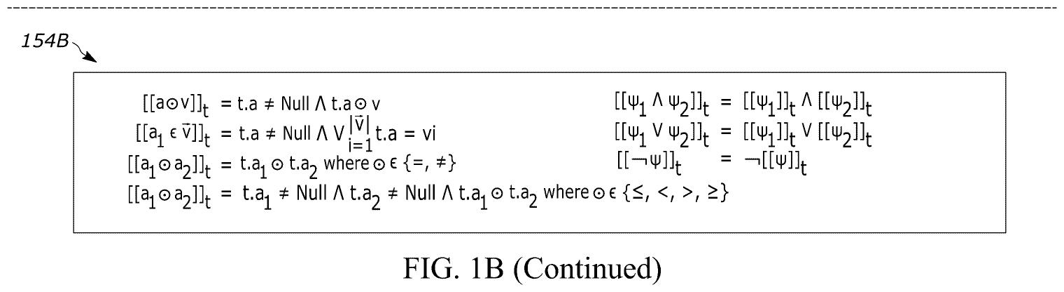

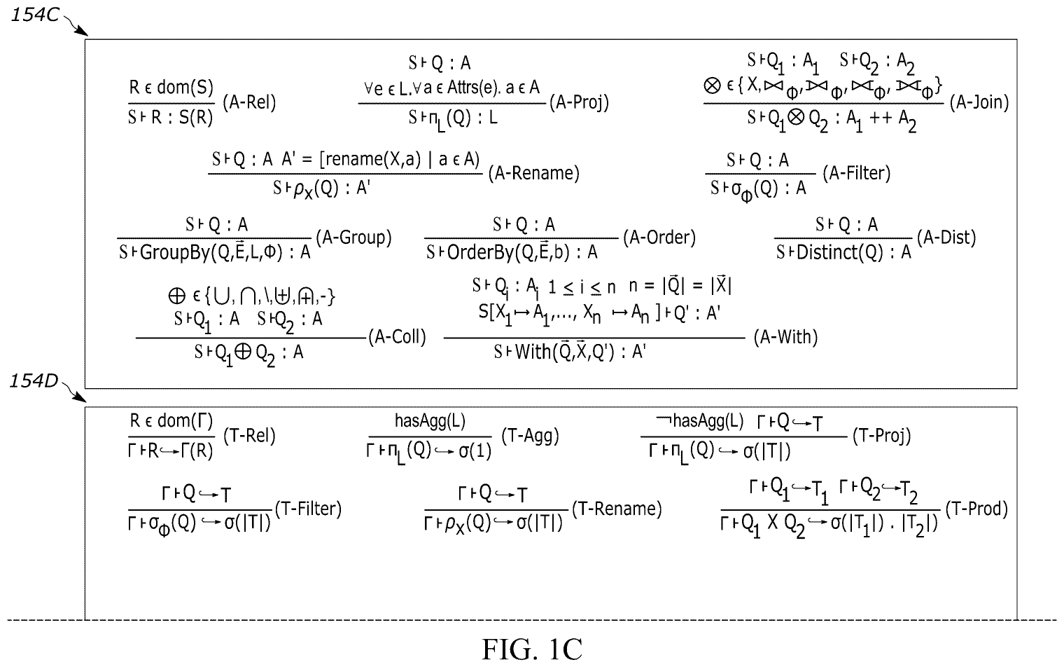

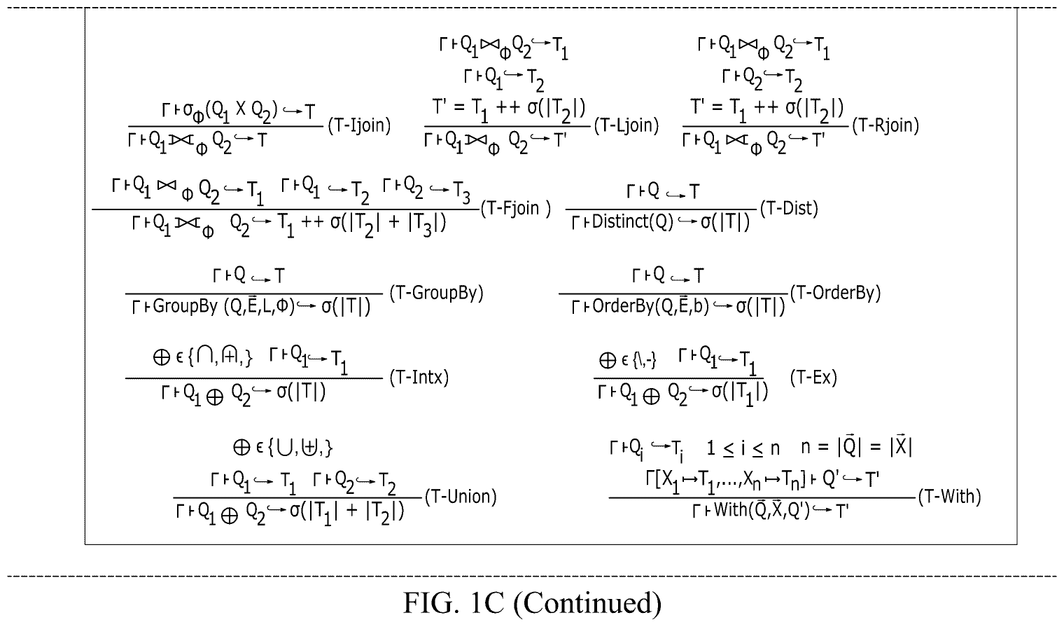

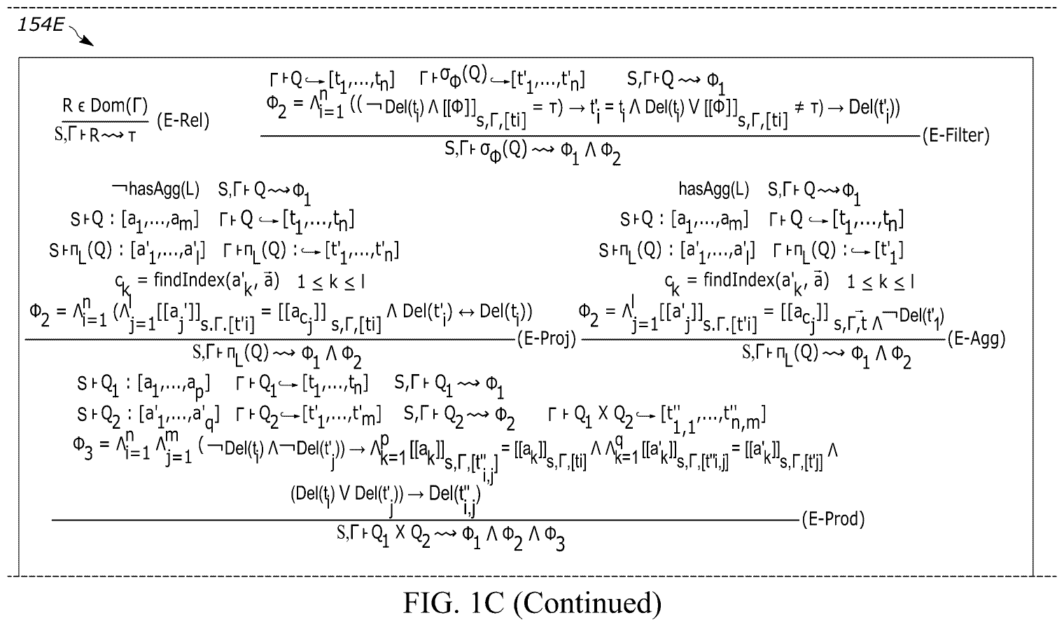

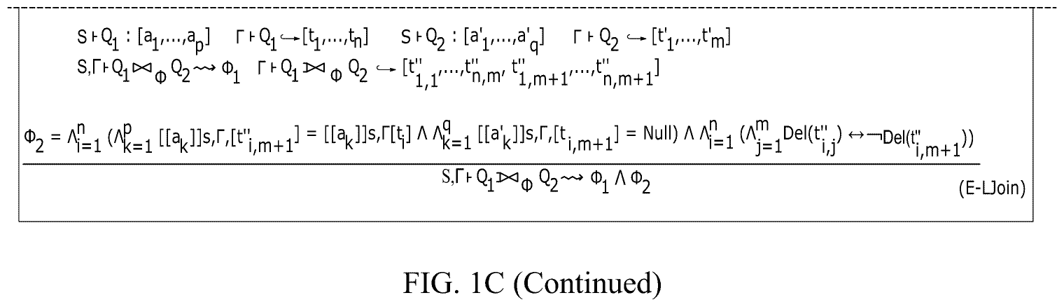

Turning first to FIG. 1A, a system 100 includes a query synthesizer 110, an equivalence checker 120, and a performance ranker 130, all communicatively coupled to a database management system (DBMS) 150. Depending on the implementation, each of the query synthesizer 110, equivalence checker 120, and performance ranker 130 may communicate internally (e.g., amongst themselves) and externally (e.g., with an external computing device communicatively coupled with the system 100). Each of the query synthesizer 110, equivalence checker 120, and performance ranker 130 may be or include computing components (e.g., one or more processors, memory, transceiver, etc.). As such, each of the query synthesizer 110, equivalence checker 120, and performance ranker 130 may be a dedicated hardware module, a combined hardware module (e.g., implementing more than one functionality as described herein), a software module implemented on computing hardware of the system 100, etc. Further, it will be understood that each of the functionalities described below may be performed by the same computing device or by some combination of different computing devices.

The system 100 may receive an input database query 105 (e.g., query Qᵢₙ) and a constraint 115 (e.g., integrity constraint. The system 100 may then generate and output a semantically equivalent output query 135 (e.g., output query Q) that is determined to be likely to run faster than the input database query 105. In some implementations, the system 100 receives the input database query 105 at the query synthesizer 110 and the constraint 115 at the equivalence checker 120. The query synthesizer 110 and the equivalence checker 120 may function as a counterexample-guided inductive synthesis (CEGIS) loop, where the query synthesizer 110 proposes a candidate query 112 that is guaranteed to produce the same outputs as the input database query 105 on a set of counterexample databases 114. The equivalence checker 120 then validates the semantic equivalence to the input database query 105.

In particular, in some implementations, the query synthesizer 110 receives an input database query 105 and determines a set of one or more query segments of the input database query 105. The query segments (e.g., such as dataflows) may be representative of at least one or more operation indicators or the one or more variables. For example, the query synthesizer 110 may determine one or more operation indicators based on one or more reserved words or symbols for the language (e.g., arithmetic operators (+, −, *, /, %, etc.), comparison operators (=, !=, < >, >, <, >=, <=, !<, !>, etc.), logical operators (ALL, AND, ANY BETWEEN, EXISTS, IN, LIKE, NOT, OR, IS NULL, SOME, UNIQUE, etc.), and/or any other such reserved words or symbols). Further, the query synthesizer 110 may similarly determine one or more variables based on one or more reserved words or symbols (e.g., int, char, string, etc.) and/or by detecting one or more words that are not reserved words. For example, the query synthesizer 110 may detect that a variable “num” is a variable integer because the query synthesizer 110 detects “int” immediately preceding it.

In some implementations, the query synthesizer 110 extracts dataflows from queries according to and/or using a dataflow extraction algorithm. For example, given a dataset P and associated context P′, the set of all dataflows in P is P′├AllDfs (P): Δ. In particular, for a query P=Q that is or includes an input table T, the algorithm may be

$$\frac{T}{⊢ AllDfs ( T ) : \{ T \}} .$$

Further, the dataflow set Δ of a select query is the union of three sets of dataflows: Δ₁ for the query Q to select from, Δ₂ for the filtering condition ψ, and Δ₃ for a target list L. Conceptually, Δ₁ contains dataflows manifested in all components of Q. That is, if Q is a nested query, Δ₁ would also include dataflows from the sub-queries. Similarly, Δ₂ and Δ₃ capture computations performed in ψ and L. The dataflows of the selection query, then, arise from the arguments Q, ψ, and L. As such, the algorithm may be

$$\frac{⊢ All D f s ( Q ) : {Δ}_{1} Q ⊢ A l l D f s ( ψ ) : {Δ}_{2} Q ⊢ A l l D f s ( L ) : {Δ}_{3}}{⊢ AllDfs ( SELECT L FROM Q WHERE ψ ) : {Δ}_{1} ⋃ {Δ}_{2} ⋃ {Δ}_{3}}$$

For a union of dataflow sets using join logic, the algorithm may similarly be

$$\frac{⊢ All D f s ( {Q}_{1} ) : {Δ}_{1} ⊢ AllDfs ( {Q}_{2} ) : {Δ}_{2} ⊢ AllDfs ( ψ ) : {Δ}_{3}}{⊢ AllDfs ( {Q}_{1} INNER JOIN {Q}_{2} ON ψ ) : {Δ}_{1} ⋃ {Δ}_{2} ⋃ {Δ}_{3}} .$$

Where P is or has a condition (e.g., a condition ψ, which can be used as a join condition or used in WHERE or HAVING operations), for a Boolean combination lop (e.g., V) of multiple conditions, the query synthesizer 110 may recursively invoke AllDfs to obtain all dataflows Δᵢ for each ψᵢ. In addition, since lop performs a logical operation, the final dataflow set also includes lop (δ₁, δ₂), where δᵢ is the dataflow for ψᵢ, excluding dataflows for the components. The system may calculate δᵢ using a second, separate function Df. The second function Df differs from the first function AllDfs in that the first function may include all dataflows for all components in P, whereas the second function may instead concern one dataflow for P itself. As such, the algorithm for extracting all dataflows for conditions may be

$$\frac{Q ⊢ A l l D f s ( {ψ}_{i} ) : {Δ}_{i} Q ⊢ D f ( {ψ}_{i} ) : {δ}_{i}}{Q ⊢ A l l D f s ( {ψ}_{1} lop {ψ}_{2} ) : {Δ}_{1} ⋃ {Δ}_{2} ⋃ \{ op ( {δ}_{1} , {δ}_{2} )} .$$

In implementations in which the condition ψ is an application of op (e.g., =) over expression(s) Eᵢ (e.g., columns of a table T), the algorithm may use the second function Df to retrieve the dataflow for the expression(s) Eᵢ, such that the algorithm may be

$$\frac{Q ⊢ A l l D f s ( {E}_{i} ) : {Δ}_{i} Q ⊢ D f ( {E}_{i} ) : {δ}_{i}}{Q ⊢ A l l D f s ( {E}_{1} op {E}_{2} ) : {Δ}_{1} ⋃ {Δ}_{2} ⋃ \{ op ( {δ}_{1} , {δ}_{2} )} .$$

In some implementations, the second function Df such that the dataflow of a logical composition (e.g., Λ) is composed of dataflows of the two arguments, and therefore

$$\frac{Q ⊢ D f ( {ψ}_{i} ) : {δ}_{i}}{Q ⊢ D f ( {ψ}_{1} lop {ψ}_{2} ) : lop ( {δ}_{1} , {δ}_{2} )} .$$

Similarly, for implementations including comparison operations (e.g., =) and utilizing the function Df on expressions E (e.g., a column), an aggregate function applied to a column, or a constant, the algorithm may be

$$\frac{Q ⊢ D f ( {E}_{i} ) : {δ}_{i}}{Q ⊢ D f ( {E}_{1} op {E}_{2} ) : op ( {δ}_{1} , {δ}_{2} )} .$$

In further implementations, for a constant, the dataflow is the constant itself (e.g.,

$$\frac{x}{Q ⊢ Df ( const ) : const} ) .$$

In still further implementations, for an input table T, the dataflow for a column col in T is T·col (e.g.,

$$\frac{T is an input table}{T ⊢ Df ( col ) : T . col} ) .$$

In some implementations, the query synthesizer 110 extracts the dataflow for a column col (or an alias for the column) given a JOIN query. In some such implementations, the query synthesizer 110 recursively extracts the dataflow for col given the query Qᵢ from which col originates. As such,

$$\frac{col ∈ Columns ( {Q}_{i} ) Q ⊢ Df ( col ) : {δ}_{i}}{{Q}_{1} JOIN {Q}_{2} ON ψ ⊢ Df ( col ) : op {δ}_{i}} .$$

Similarly, the query synthesizer 110 may identify the target t from the target list L that corresponds to col before utilizing Df on t given the query Q being selected from, such that

$$\frac{( t AS col ) ∈ L Q ⊢ Df ( t ) : δ}{SELECT L FROM Q WHERE ψ ⊢ Df ( col ) : δ} .$$

In still further implementations, the system may extract dataflows for aggregate functions according to an algorithm such as

$$\frac{Q ⊢ Df ( t ) : δ}{\begin{matrix}Q ⊢ Df ( α ( col ) \\ OVER ( PARTITION BY {cols}_{1} ORDER BY {cols}_{2} ) ) : α ( δ )\end{matrix}}$$

$$and / or$$

$$\frac{Q ⊢ Df ( col ) : δ}{Q ⊢ Df ( α ( col ) ) : α ( δ )} .$$

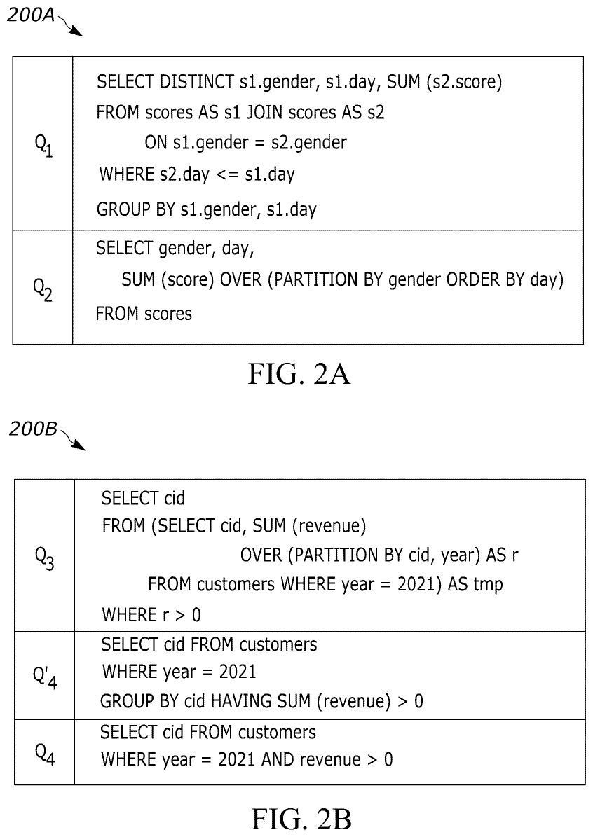

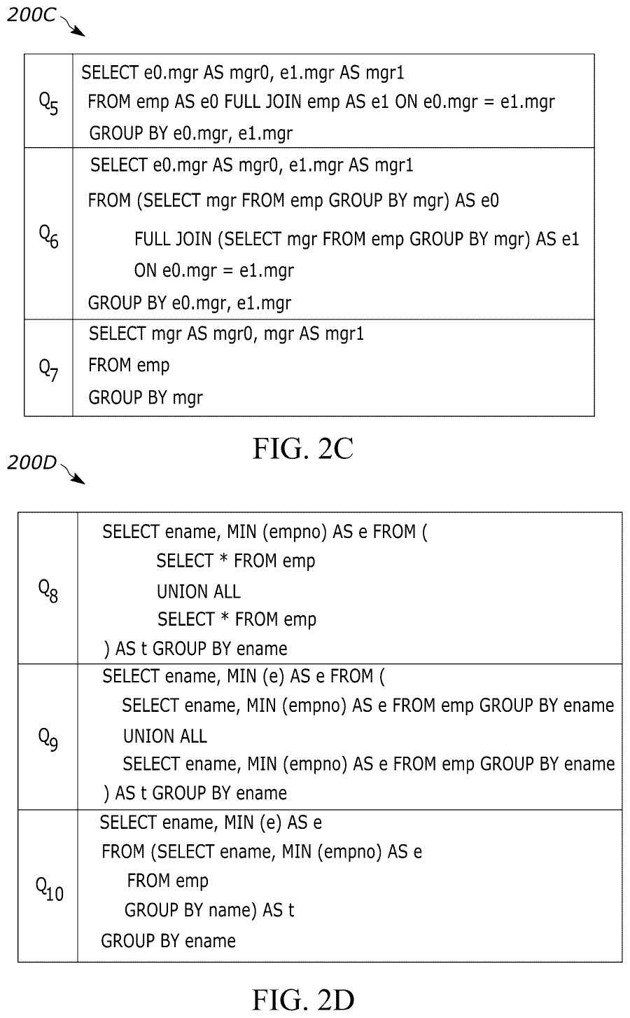

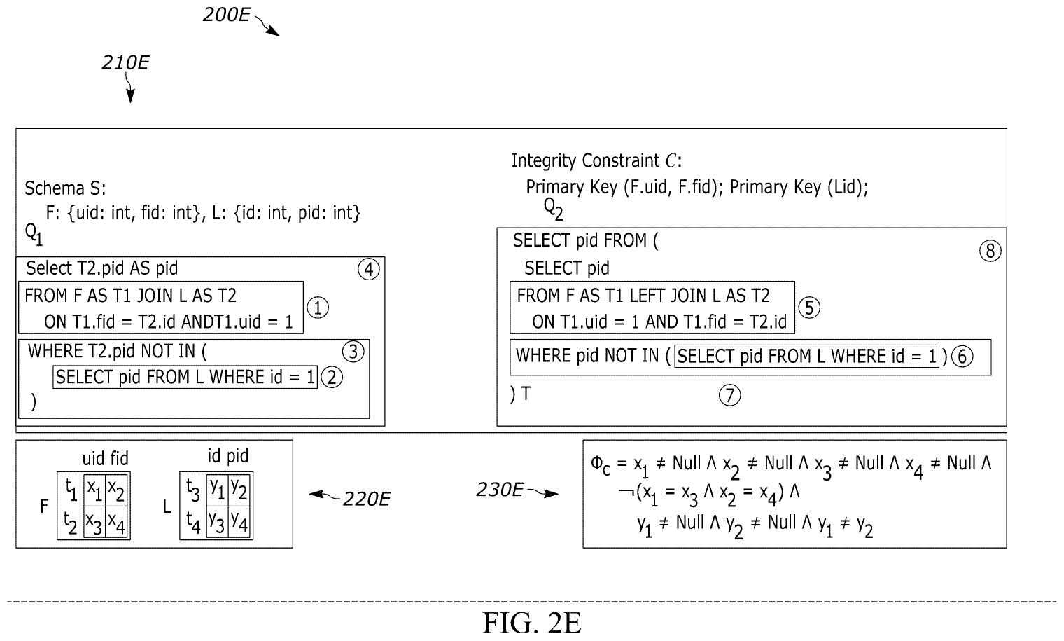

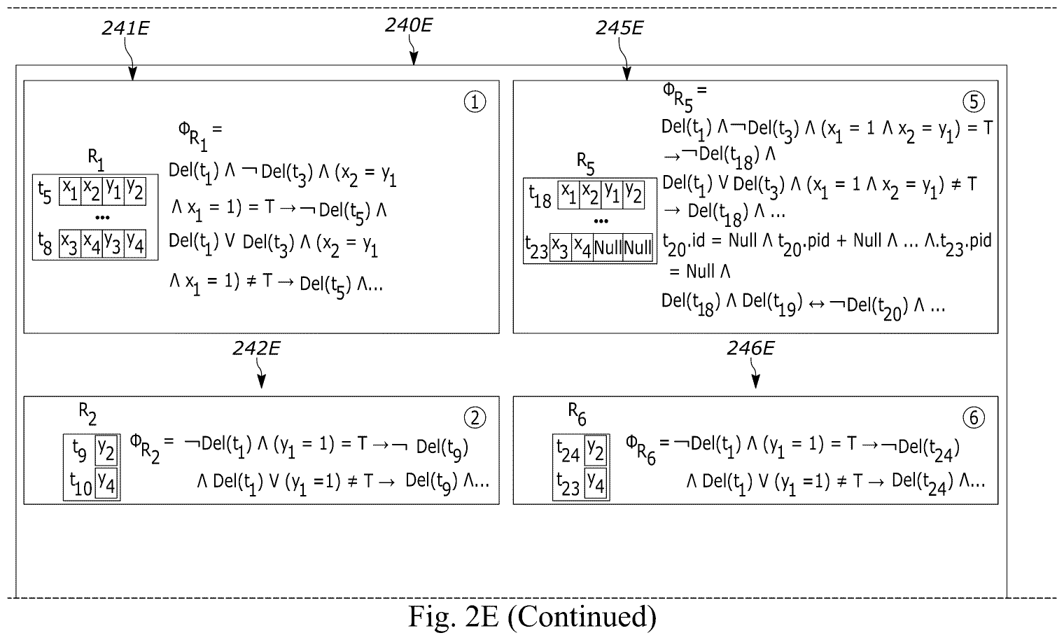

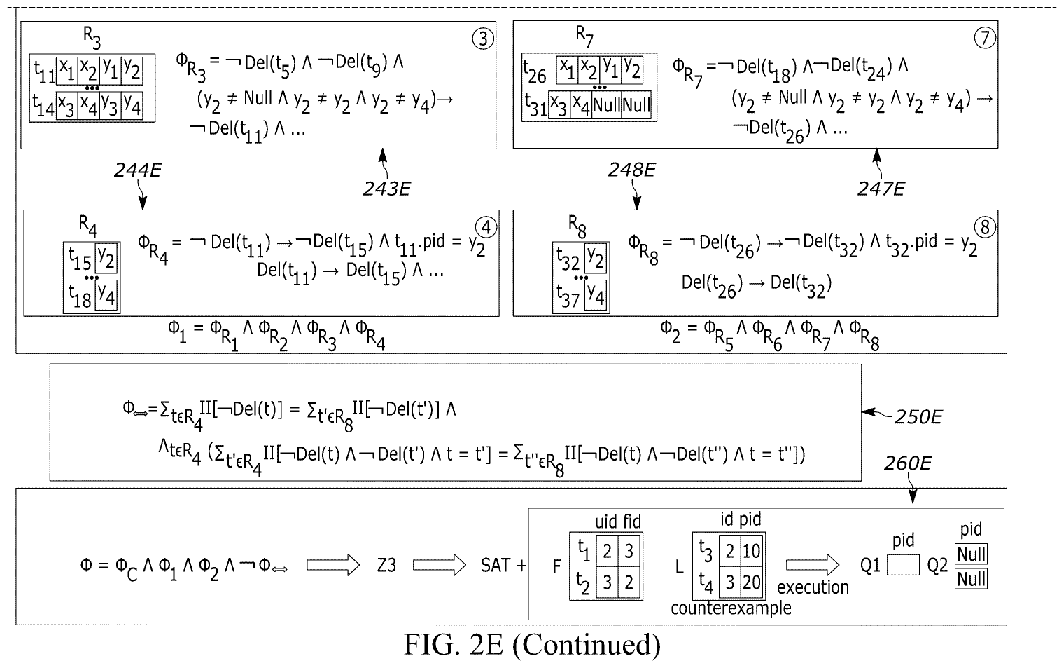

As an example, in an exemplary embodiment of FIG. 2A, as described in more detail below, the table 200A uses Q₁ as an input. The query synthesizer 110 may extract the dataflows from a component of the query Q₁, s2.day<=s1.day In particular, the dataflows of the component expression include the union of three sets of dataflows: (1) the dataflows of the left argument (e.g., {scores.day}), (2) the dataflows of the right argument (e.g., {scores.day}), and (3) the dataflow from the comparison operation (e.g., {scores.day<=scores.day}). As such, the query may use data from the day column of the input scores table and perform a comparison where the left and right arguments originate from the day column of the scores table as well. The query synthesizer 110 may use the dataflows to guide the search.

Depending on the implementation, the query synthesizer 110 may transmit query databases 116 to the DBMS 150 and receive query outputs 118 from the DBMS 150. In some implementations, the query synthesizer transmits the query databases 116 for the initial input database query 105 to determine what the initial output of the input database query 105 is for purposes of extracting the query segments, as described above. After extracting the query segments, the query synthesizer 110 may perform a scoring functionality.

In some implementations, the query synthesizer 110 performs scoring based on the dataflows. In particular, the query synthesizer 110 may use a score function to calculate a score for a query Q against an input query Qᵢₙ. In particular, the query synthesizer 110 may extract two sets of dataflows Δᵢₙ and Δ for Qᵢₙ and Q, respectively. The query synthesizer 110 may use the extraction algorithms described above with regard to block 504 for extracting the dataflows. The query synthesizer 110 may then compute the set difference (i.e., Δ_{diff}=Δ−Δᵢₙ), which gives the dataflows in Q but not in Qᵢₙ. Then, the query synthesizer 110 may define S (Q|Qᵢₙ)=−Δ_{diff}|. In such implementations, 0 is the highest possible score. A 0 may mean, then, that Q does not include dataflows not present in Qᵢₙ.

In some implementations, the score function is monotonic. As such, in such implementations, given Qᵢₙ and Q, then for any component P (e.g., a sub-query) of Q, score(P|Qᵢₙ)≥score(Q|Qᵢₙ). P may be, for example, a sub-query in Q, a filter condition used in Q, a target list, etc. As such, because the dataflow set for P is a subset of that for Q, the score for P is no less than the score for Q. Conceptually, when composing multiple programs P₁, . . . , Pₙ to form a bigger program P, the score for P is not higher than the score for any Pᵢ.

In some implementations, the monotonicity property of the score function is used to develop a stratified search algorithm that enumerates programs in layers. In particular, the query synthesizer 110 first finds all programs with a highest score (e.g., 0 in the above example) without considering programs with lower scores. The query synthesizer 110 then finds all programs with a score one step below (e.g., −1 in the above example). In some implementations, the query synthesizer 110 finds all programs within certain score brackets before moving to the next (e.g., −1 to 0, −3 to −2, −5 to −4, etc.). In some such implementations, the query synthesizer 110 generates only programs with a given score S without searching programs with lower scores, limiting the time and resources spent in the search process (e.g., via enumerating low-quality candidates). In particular, to avoid searching programs with lower scores, the system may only keep track of programs with a score of at least S, because such programs are sufficient for the query synthesizer 110 to generate all programs with a score matching S because of the monotonicity property of the scoring algorithm.

In further implementations, the query synthesis process is carried out in a bottom-up manner. In particular, the query synthesizer 110 determines a set of smaller queries (i.e., smaller in query size) scored as S, given all queries scored higher than S. The query synthesizer 110 may then use all current queries scored as at least S as building blocks to generate more queries with a score of S. The query synthesizer 110 may continue to perform the iterative process until no more new queries with score S are produced.

In some implementations, the synthesis algorithm for constructing a program with a score of exactly S may be

$$\frac{{P}_{1} , … , {P}_{n} P score ( P \vert {P}_{1} , … , {P}_{n} ) = S}{P ∈ {Programs}_{{P}_{1} , … , {P}_{n}}^{S}} ,$$

where Programs_{P}_{₁}_{, . . . ,P}_{ₙ}^{S} is the set of programs with score exactly S that can be constructed from programs P₁, . . . , Pₙ. In further implementations, the synthesis algorithm for construction a program with a score of at least S may be

$$\frac{P ∈ {Programs}^{\geq S + 1} or P ∈ {Programs}^{S}}{P ∈ {Programs}^{\geq S}} .$$

In still further implementations, the synthesis algorithm may be a composition algorithm (e.g., an algorithm used to obtain a program with a score of at least S and in the form

$${P}_{1} , … , {P}_{n} P ) ,$$

namely

$$\frac{x}{{PP}_{1} , … , {P}_{n} P} ,$$

where x depends on the properties of the programs, as described below.

Depending on the implementation, Programs may include queries, conditions, target lists, etc. For example, the algorithm may generate all queries (e.g., Queries) with score exactly S as follows:

$$\frac{Q score ( Q ) = S}{Q ∈ {Queries}^{S}} .$$

In particular, where the program is or includes an input table with a score of at least S, the composition algorithm may be

$$\frac{T is an input table with score at least S}{T} .$$

In further implementations, the algorithm builds up selection queries by invoking the algorithm for scores of at least S, and the composition algorithm may therefore be

$$\frac{Q ∈ {Queries}^{\geq S} ψ ∈ {WhereConds}_{Q}^{\geq S} L ∈ {TargetLists}_{Q}^{\geq S}}{SELECT L FROM Q WHERE ψ} .$$

In particular, the SELECT query may be composed of three arguments (e.g., Q, L, and cols), all of which have a score of at least S. In some such implementations, the query synthesizer 110 may ignore arguments with scores less than S due to the monotonicity property of the score function.

Similarly, the algorithm may generate all target lists with a score of at least S, and the algorithm may then be

$$\frac{{t}_{i} ∈ {Targets}_{Q}^{\geq S} {alias}_{i} is a fresh column alias}{Q [ {t}_{1} AS {alias}_{1} , … , {t}_{n} AS {alias}_{n} ]} .$$

Moreover, the algorithm may generate targets, and the algorithm may then be

$$\frac{col ∈ {Columns}^{\geq S} ( Q )}{col} or \frac{col ∈ {Columns}^{\geq S} ( Q )}{α ( col )} .$$

In some implementations, the overall computation is carried out in a bottom-up fashion between layers. In particular, the query synthesizer 110 first computes all programs (including queries, conditions, target lists, etc.) with a score of exactly 0 and at least 0. Then, the query synthesizer 110 proceeds to compute programs with scores of exactly 1 and at least 1, again using the synthesis algorithm. The query synthesizer 110 performs the process iteratively within each layer, reusing past results, until no new programs with score S are generated.

The equivalence checker 120 may utilize at least three types of functionalities to check the equivalence of a candidate query 112. In particular, the equivalence checker 120 may use a testing functionality, a bounded verifying functionality, and a full verifying functionality. It will be understood that the equivalence checker 120 may use any of the above functionalities individually or in combination and/or may use additional functionalities in confirming the equivalence of the candidate query 112 to the input database query 105. If the equivalence checker 120 finds a counterexample database (e.g., counterexample database 114), the candidate query 112 is rejected and the counterexample database 114 is returned as feedback to the query synthesizer 110. Generally, the equivalence checker 120 functionalities may provide an example pair 122 (e.g., an example database and query pair) to the DBMS 150 and receive a query output pair 124 indicative of the outputs of each piece of the example pair 122. The equivalence checker 120 may then determine if the query output pair 124 match. If so, the equivalence checker provides the equivalent queries 125 to the performance ranker. More specifically, if the full verifying functionality can prove equivalence within a user-set timeout period, then the query is marked as fully verified and is passed to the performance ranker 130. Otherwise, if the timeout expires, the query receives an additional flag indicating that the query is only correct under bounded verification before being passed to the performance ranker 130.

In some implementations, the system 100 tests the queries by receiving an input query Qᵢₙ, a candidate query Q, and an integrity constraint ϕ, and outputting either (1) a database D which satisfies ϕ such that Qᵢₙ and Q produce different tables on D (e.g., a counterexample), or (2) an “unknown” indication, indicating that the system 100 does not find a counterexample. In some such implementations in which the system 100 returns an unknown indication, Qᵢₙ and Q may be equivalent, or the system 100 may not be able to disprove equivalence.

In some such implementations, because databases that produce non-empty outputs may be useful in disproving equivalence, the system 100 extract filter conditions (e.g., those in a WHERE operation) from Qᵢₙ and populates the test database with rows that satisfy the conditions. Similarly, the system 100 may collect JOIN conditions to generate inputs that do not produce empty intermediate join results. In some such implementations, the system 100 may do so by enforcing the JOIN mapping between tables. In particular, the system requires that (1) the tables that are to be joined have the same number of rows and (2) the i-th row of one table is joined with the i-th table of the other table. For self-joins, the system 100 may split the table into two halves, which reduces the problem to a normal join.

In further such implementations, the system 100 may identify incorrect logic around operations (e.g., addition and removal) and keywords (e.g., DISTINCT) placed in a wrong location. The system 100 may therefore generate potentially useful test inputs based on the identified operations and keywords. For example, if Q has DISTINCT on a column C, the system 100 may generate a test database with duplicated values in C, with the goal of triggering the DISTINCT logic.

In yet further such implementations, the system 100 may identify query candidates with incorrect GROUP BY clauses by search for and/or detecting columns in GROUP BY of Q that are different from those in Qᵢₙ. Then the system 100 generates test databases that contain duplicated values in such columns. In some implementations, the duplicated values from the grouped columns are eventually eliminated and, as such, such inputs are likely to produce different outputs for two queries with different GROUP BY clauses.

In still further implementations, the system 100 performs the testing at block 510 after generating mutant database queries. In particular, the system 100 mutates the input database query using a predefined set of mutation rules to generate at least one mutant database query. The system 100 may then generate the one or more test cases including at least one test input for each mutant database query such that a mutant output for the corresponding mutant database query differs from an output of the input database query.

In some implementations, the mutation rules identify (e.g., via pattern-matching) part of a query to mutate, and then actually changes the identified portion to something else (e.g., as encoded by the mutation rule) to obtain the mutant. In general, the input and the mutant are not equivalent. Depending on the implementation, a plurality of mutants are generated. In further implementations, the mutants are representative of potential mistakes for producing non-equivalent queries. Then, for each pair, the system 100 generates at least one test input that differentiates the input query and the mutant (e.g., such that each returns a different output).

The system 100 may further encode each set of test databases into a logical formula φ₁ and the integrity constraint into a formula φ₂. The system may use a constraint solver (e.g., Z3, MIP, SAT, SMP, etc.) to generate satisfying assignments for φ₁Λφ₂, where each satisfying assignment corresponds to one database instance.

In some implementations, the system 100 uses a bounded verifier to check equivalence and find counterexamples. In particular, the system 100 verifies by considering all inputs in a bounded space, and therefore may be more exhaustive than the testing functionality. In some implementations, if verified, the system 100 guarantees that Qᵢₙ and Q produce the same output for all input databases that have up to k rows (e.g., customizable by a user), though cell values are not bounded. In further implementations, the system 100 may use a full verifier to prove query equivalence against all possible inputs. In some such implementations, the system 100 may use full verification selectively (e.g., when the testing functionality and bounded verification functionality are not able to disprove a query) to save resources.

In some implementations, the system 100 includes a performance ranker 130 to select a query with the best performance among the equivalent queries 125. In some implementations, the performance ranker 130 and/or another component of the system 100 can determine the performance (e.g., the costs 134) of a given query and database 132 by running candidate queries against a small sample of the data to determine the query latency. In further implementations, the performance ranker 130 and/or another component of the system 100 determines a proxy for the performance of a given query and database 132 according to an EXPLAIN cost estimate. In still further implementations, the system 100 determines the performance of a given query and database 132 by running the candidate query against the entire data set (e.g., when the overhead can be justified, such as for reporting dashboards where the same query will run many times). The performance ranker 130 then ranks at least some of the candidate queries (e.g., the equivalent queries 125) based on performance to determine the output query 135.

FIG. 1B illustrates an example block diagram depicting an expanded view of the equivalence checker 120, implemented in FIG. 1A. In some implementations, the equivalence checker 120 includes a symbolic database generator 152, a query encoder 154, an equality checker 156, and a constraint solver 158. Depending on the implementation, the equivalence checker 120 may include additional, fewer, and/or alternate components to those described herein.

Generally, the equivalence checker 120 takes a pair of queries (Q₁, Q₂), a database scheme S with integrity constraint C, and/or a bound N defining the input space as an input. The equivalence checker may then construct an SMT formula ϕ such that: (i) if ϕ is unsatisfiable, then Q₁ and Q₂ are guaranteed to be equivalent for all database relations with at most N tuples, and (ii) if ϕ is satisfiable, then Q₁ and Q₂ are provably non-equivalent, and the equivalence checker 120 generates a counterexample (i.e., a database that meets C but leads to different query outputs) from ϕ's satisfying assignments.

In some implementations, the symbolic database generator 152 first creates a symbolic representation Γ of all input databases with up to N tuples in associated relations. The symbolic database generator 152 further encodes the integrity constraint C over Γ into an SMT formula ϕ_{C}. Then, in some implementations, the query encoder 154 processes both queries (e.g., Q₁ and Q₂) and encodes the equivalence of such into an SMT formula ϕ_{R}. In particular, the query encoder 154 traverses Qᵢ in a forward fashion, encodes how each operator in Qᵢ transforms an input to an output, and obtains the final output Rᵢ of Qᵢ for all input databases under consideration.

In particular, the symbolic database generator 152 generates a database such that the database schema S: Relation→[Attribute] is a mapping from relations in the database to their corresponding lists of attributes. The domain of S, denoted by Dom(S), is the collection of all relations in the database. As an example, given a schema S and a bound N for the size of relations, the symbolic database generator 152 builds a symbolic database containing all relations in Dom(S), and each relation has N symbolic tuples. The symbolic database may be denoted as Γ, where Γ: Relation→[Tuple] maps relations to corresponding lists of symbolic tuples. In general, an uninterpreted predicate Del(t) for each tuple t indicates whether or not t is deleted by subquery. Since the Del predicates hold non-deterministic values in the symbolic database, Γ can be used to encode all possible databases where each relation has at most N tuples.

Further, given a symbolic database Γ and an integrity constraint C, the query encoder 154 follows the semantics of C to encode C as an SMT formula over Γ. The encoding procedure is summarized as inference rules 154A where judgments of the form Γ ├C [symbol] ϕ represent that the encoding of integrity constraint C is ϕ given a symbolic database Γ. In particular, the query encoder 154 may encode each atomic integrity constraint in C and conjoin formulas together according to the IC-Comp rule (e.g., in inference rules 154A). Specifically, the IC-PK rule (e.g., in inference rules 154A) specifies that the encoding of a primary key constraint PK(R, α) consists of two parts: ϕ₁ asserting all attributes in the primary key have no NULL values, and ϕ₂ stating for any pair of tuples t₁ and t₂ where t₁≠t₂, the pair do not agree on all attributes in \vec{a}. For FK (R₁, a₁, R₂, α₂) where R₁·α₁ is a foreign key referencing R₂·α₂, the IC-FK rule (e.g., in inference rules 154A) looks up the symbolic database Γ and finds the tuples for R₁ are t₁, . . . , tₙ and the tuples for R₂ are t₁′, . . . , tₘ′. The formula asserts that, for each tuple tᵢ in R₁, there exists a tuple tⱼ′ in R₂ such that the value of tᵢ·α₁ is equal to tⱼ′·α₂. The IC-NN rule (e.g., in inference rules 154A) encodes that NotNull(R, α) requires that all tuples in R must have a non-NULL value on attribute a. For the constraint Check (R, ψ) that specifies ranges of values, the IC-Check rule (e.g., in inference rules 154A) uses an auxiliary function [[ψ]]ₜ (shown in predicate rules 154B) to compute the formula of predicate ¿ on each tuple tᵢ in R and obtain the formula by conjoining the [[ψ]]ₜ formulas together. For the auto-increment constraint Inc(R, α, v), the IC-Inc rule (e.g., in inference rules 154A) also looks up the symbolic database I′ and finds all tuples t₁, . . . tₙ of R. The IC-Inc rule then enforces the value of t₂·α is not NULL and that tᵢ·α=v+i−1.

Moreover, the query encoder 154 encodes database queries. In particular, to infer the attributes of each intermediate subquery to encode the database queries, the query encoder 154 uses an algorithm for all query operations in the database language. The algorithm is summarized as a set of inference rules 154C. The judgments of the form S├Q: A mean the attributes of query Q is A under scheme S.

Specifically, the attributes of a relation in the initial database can be obtained by looking up the schema S directly (A-Rel). To find all attributes of a projection II (Q), the A-Proj rule first computes the attribute list A of query Q and then checks if all attributes that occurred in the attribute expression list L belong to A. If so, the attributes of Π_{L}(Q) are L with all attribute expressions converted to the corresponding attribute names (e.g., Avg(a) to Avg_a).

Otherwise, the query encoder 154 determines that there is a type error in the query. For Cartesian product or any join operator ⊗, the attributes of Q₁⊗Q₂ are obtained by concatenating the attributes of Q₁ and those of Q₂ (A-Join). The renaming operation ρ_{X}(Q) first computes the attributes of Q and then renames each of the attributes according to the new relation name X in the result (A-Rename). Based on the A-Filter, A-Group, A-Order, and A-Dist rules, the filtering, GroupBy, OrderBy, and Distinct operations do not change the attribute list. The A-Coll rule specifies that, for any collection operator ⊕, the attributes of the two operands Q₁ and Q₂ must be the same, which are also identical to the attributes of Q₁⊕Q₂. The inference rule for a WITH clause With(\vec{Q}, \vec{X}, Q′) is slightly more involved. Since the query Q′ can use Xᵢ to refer to the results of a subquery Qᵢ, the A—With rule first infers the attributes Aᵢ of each subquery Qᵢ and then augments the schema S to a temporary new schema S′ by adding entries Xᵢ [symbol] Aᵢ. Finally, the attributes of query Q′ (and the whole WITH clause) is inferred based on the schema S′.

Similar to the database schema, a symbolic database ⊖ only describes those tuples in each relation of the initial database, but does not present what tuples are in the result of intermediate subqueries. To obtain the tuples in each intermediate subquery, the query encoder 154 uses a set of inference rules as shown in inference rules 154D, where judgments of the form Γ├Q [symbol] τ mean the result of query Q has a list of symbolic tuples τ given the initial database Γ.

The inference rules 154D ensure that the query encoder 154 computes the number (at most) of symbolic tuples in the result of each intermediate subquery and corresponding names. As such, the query encoder 154 looks up the tuples for relations in Γ (T-Rel) and generates fresh tuples for other queries. Specifically, if a projection Π_{L}(Q) has aggregate functions in the attribute expression list L, there is only one tuple in the result (T-Agg). But if the projection ┌_{L}(Q) does not have aggregate functions, the number of tuples in the result is the same as that in Q. For filtering σ_{ϕ}(Q), the T-Filter rule generates the same number of tuples as Q, because the predicate ϕ may not filter out any tuple from Q. The T-Rename rule specifies that the renaming operation ρ_{X}(Q) produces the same number of tuples as Q. Given the tuples of Q₁ are τ₁ and the tuples of Q₂ are τ₂, the numbers of fresh tuples for the Cartesian product, inner join, left outer join, right outer join, and full outer join are |τ₁|·|τ₂|, |τ₁|·τ₂|, (|τ₂|+1), (τ₁+1)·|τ₂|, and |τ₁|·|τ₂|+|τ₁|+|τ₂|, respectively. In addition, the numbers of fresh tuples for union, intersect, and except operations of Q₁ and Q₂ are |τ₁|+|τ₂|, |τ₁|, and |τ₁|, respectively. According to the T-Dist, T-GroupBy, and T-OrderBy rules, the Distinct, GroupBy, and OrderBy operation preserves the number of tuples in their subqueries. Finally, to infer the tuples for With(\vec{Q}, \vec{X}, Q′), the query encoder 154 first obtains the tuples τᵢ for the subquery Qᵢ. Then the system 100 creates a new symbolic database I′ by adding mappings from tuples τᵢ to relation Xᵢ to Γ. Finally, the query encoder 154 infers the tuples τ′ for Q′ given the new symbolic database Γ′ and determines the result of With(\vec{Q}, \vec{X}, Q′) based on the T-With rule.

Since the database query language supports various complex attribute expressions and predicates, the query encoder 154 uses two auxiliary functions [[e]]_{S,Γ,τ} and [[ϕ]]_{S,Γ,τ} to encode attribute expressions and predicates in a query, respectively. Further, [[⋅]]_{S,Γ,τ} evaluates an attribute expression or a predicate in a recursive fashion given the schema S, database Γ, and a list of tuples τ. For example, if a is an attribute of a relation and t is a tuple of the relation, [[α+1]]_{S,Γ,[t]}=[[a]]_{S,Γ,[t]}+[[1]]_{S,Γ,[t]}=t·α+1.

The encoding algorithm for query operators is represented as a set of inference rules 154E. Judgments are of the form S, Γ├ [symbol] ϕ, meaning the encoding of query Q is formula ϕ given schema S and database Γ. It will be understood that the inference rules 154 (as well as other sets of rules 154A-D) are exemplary only and should not be considered to be an exhaustive list.

In some implementations, the encoding for a simple relation query is T, because the result can be obtained from the database Γ directly (e.g., the output is the same as the input). In further implementations, the E-Filter rule specifies how to encode filtering operations. In particular, given a query σ_{ϕ}(Q), the query encoder can first determine the input (result of Q) is [t₁, . . . , tₙ] and the output should be [t₁′, . . . , tₙ] based on the inference rules 154D. The query encoder 154 then generates a formula ϕ₂ to describe the relationship between [t₁′, . . . , tₙ′] and [t₁, . . . , tₙ]. Specifically, if a tuple tᵢ is not deleted an the predicate ϕ evaluates to be T on tᵢ, then the tuple is retained in the result (e.g., tᵢ′=tᵢ). Otherwise, the corresponding output tuple tᵢ′ is deleted. The final formula encoding σ_{ϕ}(Q) is the conjunction of ϕ₂ and the formula ϕ₁ that encodes Q.

In further implementations, according to the E-Proj rule, to encode Π_{L}(Q) where L does not contain aggregate functions, the system 100 can infer that the input is [t₁, . . . , tₙ] with attributes [a₁, . . . , aₙ] and output is [t₁′, . . . , tₙ′] with attributes [a₁′, . . . , aₙ′] based on the inference rules (e.g., inference rules 154C and 154D). Then for each aₖ′, the query encoder 154 finds a corresponding index cₖ in the attributes of Q and generates a formula Ø2 that asserts, for each tuple and corresponding output (tᵢ, tᵢ′), they have the same Del status and agree on attribute aₖ′. The E-Agg rule for encoding projection with aggregate functions is similar to E-Proj, except that the query encoder 154 only generates one tuple t₁′ in the output and sets the aggregated value based on all input tuples (i.e.,

$${[ [ {a}_{j}^{′} ] ]}_{S , Γ , [ {t}_{1}^{′} ]} = {[ [ {a}_{{c}_{j}} ] ]}_{S , Γ , \vec{t}} .$$

Based on the E-Prod rule to encode Q₁× Q₂, the system 100 generates a formula ϕ₃ that encodes an output tuple t_{i,j}″, obtained by concatenating a tuple tᵢ from Q₁ and a tuple tⱼ′ from Q₂. Specifically, 3 describes the attributes of t_{i,j}″ agreeing with those of tᵢ and tⱼ, and t_{i,j}″ is deleted if either tᵢ or tⱼ′ is deleted.

The E-LJoin rule specifies the encoding of a left outer join Q₁ [symbol] Q₂ is based on the formula ϕ₁ of inner join Q₁ [symbol] Q₂ (which is a syntactic sugar of σ_{ϕ}(Q₁×Q₂). In addition to ϕ₁, the encoding also includes ϕ₂, which describes the output tuples from the null extension of Q₁.

Depending on the implementation, the additional rules 154E for encoding other query operations are similar to the above. Specifically, the high-level idea is to first obtain the schema and tuples for the input and output based on the inference rules 154C and/or 154D. Then the query encoder 154 encodes the relationship between the input and output tuples and generates a formula that encodes the query semantics.

It will be understood that, although the above discusses checking equality under bag semantics, it will be understood that other techniques are also applicable (e.g., checking equality under list semantics (e.g., by encoding the following two properties to assert R1 and R2 are equivalent under list semantics: R1 and R2 have the same number of non-deleted tuples and the tuples with the same index in R1 and R2 are equal)).

In further implementations, the equality checker 156 then generates an SMT formula ϕ_{R} that asserts R₁≠R₂ (e.g., supporting bag and list semantics). In some implementations, the encoding performed by query encoder 154 and equality checker 156 provides advantages over conventional systems. For example, as the encoding is based on the theory of integers with uninterpreted functions, the encoding is simple yet sufficient to precisely encode all SQL features (e.g., complex aggregate functions with grouping and previously unsupported operators like ORDER BY). Moreover, the encoding as described herein is able to support such advanced SQL features without needing additional axioms, which conventional systems would otherwise require. Further, the encoding may follow the three-valued logic and support NULL for all operators, whereas conventional systems support NULL for significantly fewer cases.

In still further implementations, the constraint solver 158 and/or another component of the equivalence checker 120 constructs ϕ=ϕ_{C}Λϕ_{R} and uses an SMT solver to solve for ϕ. Notably, ϕ considers both query semantics and integrity constraints in a simpler and more unified manner than conventional systems (e.g., systems that perform symbolic encoding for queries but use rewrite rules for integrity constraints).

Although depicted as individual modules, it will be understood that, in some implementations, the system 100 may be in a single computing device and/or multiple computing devices (e.g., connected by a network). The network (not shown) may be any network or combination of networks of computing devices that enable devices to communicate with one another. For example, the network can be any one or any combination of a LAN (local area network), WAN (wide area network), telephone network, wireless network, point-to-point network, star network, token ring network, hub network, or other appropriate configuration.

The modules and/or elements of system 100 may be connected using TCP/IP and use other common Internet protocols to communicate, such as HTTP, FTP, AFS, WAP, etc. Users may access the systems by utilizing different platforms and frameworks, e.g., by using single-page client applications that use HTML, and TypeScript.

In further implementations, the system 100 may include or be communicatively coupled to computing devices (not shown) associated with enterprise users who run applications over the network (e.g., for data analytics or other operations as described herein), as well as users who may access the data cloud via respective user computing devices (not shown).

FIGS. 2A-2D illustrate exemplary queries written by humans and improved, equivalent outputs as generated by the methods described herein. It will be understood that each of FIGS. 2A-2D is exemplary only, and that various implementations may cause different, additional, and/or improved outputs to be generated compared to those illustrated.

FIG. 2A depicts a table 200A with a human-written input query Q₁ and an input query Q₂ generated by a system as described herein (e.g., system 100 of FIG. 1A). In the exemplary embodiment of FIG. 2A, the queries in table 200A are written to access a table “scores” for a competition held between teams of different genders and with three columns (gender, day, score) where (gender, day) is the primary key and find the running total score for each gender on each day.

Q₂ is faster than Q₁ (e.g., more than 2000 times faster on a database randomly populated with one million rows). In particular, Q₁ uses a self-join to compute the running total, which generates a large intermediate result. The same running total can be obtained using a window function, as shown in Q₂. Further, the use of DISTINCT in Q₁ is redundant, since (gender, day) is the primary key. A rewriting rule-based method may be unable to efficiently improve Q₁ in such a way, as almost every part of the query would have to change. Moreover, anticipating such patterns in advance and writing a rule to address such in advance would be difficult, time intensive, and/or resource intensive. Moreover, a rule-based system would require numerous constraints to be satisfied to ensure equivalence, requiring a complex and time/resource intensive pattern-matching technique to be utilized. A system 100 implementing the techniques described herein directly searches the query language rather than performing constraint checking and pattern-matching operations, allowing the system 100 to discover semantically equivalent and faster queries that may be different syntactically.

FIG. 2B depicts a table 200B with a human-written input query Q₃ and input queries Q₄′ and Q₄ generated by a system as described herein (e.g., system 100 of FIG. 1A). In the exemplary embodiment of FIG. 2B, the queries in table 200B are written to access a table “customers” for reporting customers with positive revenue in a given year and with three columns (cid, year, revenue) where (cid, year) is the primary key and find the running total score for each gender on each day.

Q₄′ and Q₄ are faster than Q₃ (e.g., 1.27 times faster and 5.47 times faster, respectively, on a database with one million rows). In the exemplary embodiment of FIG. 2B, the system 100 would generate both Q₄′ and Q₄, but return Q₄ as having superior performance. In particular, Q₃ uses an unnecessary window function with PARTITION BY. Q₄′ achieves the same goal faster by replacing the window function with aggregation and GROUP BY. Because (cid, year) is the primary key, once year is fixed, there is only a tuple for each unique value of cid. That is partitioning by (cid, year) and grouping by cid when year is predetermined (e.g., year=2021) leads to the same groups. Exploiting the integrity constraint further, the system 100 implementing the instant techniques is able to find a further improved query Q₄. In particular, the summation is unnecessary because each (cid, year) also determines a unique revenue. Capturing such a rewrite for rule-based techniques is difficult, as such techniques heavily rely on pattern-matching and the ability to exploid integrity constraints is largely limited to local changes (e.g., removing redundant grouping columns or redundant left joins).

FIG. 2C depicts a table 200C with a human-written input query Q₅, an input query Q₆ generated using rules-based rewriting techniques, and an input query Q₇ generated by a system as described herein (e.g., system 100 of FIG. 1A). In the exemplary embodiment of FIG. 2C, the queries in table 200C are written to access a table “emp” with three columns (empno, ename, mgr) with empno as the primary key. Q₅ performs a full self-join of emp on the mgr column, grouped by the join key (e.g., equivalent to using DISTINCT to return only distinct values). Q₆ is faster than Q₅ (e.g., 926 times faster on a database with four million rows) and Q₇ is faster than both Q₆ and Q₅ (e.g., 1833 times faster than Q₅).

Q₆ is faster than Q₅ because moving GROUP BY before the self-join leads to smaller join operands and, as such, a more efficient execution. However, self-join can be eliminated completely in the exemplary embodiment of FIG. 2C while maintaining an equivalent input query, improving the speed further. Rule-based techniques fail to capture the information that the joined columns come from the same table and, as such, are identical, which can be exploited to eliminate redundancy. In particular, identifying self-joins would use semantic information that the two join operands are essentially the same relation, which is not easily implemented via rules-based techniques.

FIG. 2D depicts a table 200D with a human-written input query Q₈, an input query Q₉ generated using rules-based rewriting techniques, and an input query Q₁₀ generated by a system as described herein (e.g., system 100 of FIG. 1A). In the exemplary embodiment of FIG. 2D, the queries in table 200D are written similarly to the exemplary embodiment of FIG. 2C. Q, is faster than Q₈ (e.g., by ±2% latency) by pushing GROUP BY past UNION ALL. Q₁₀ is faster than Q₉ (e.g., by 1.7 times) because both sides of UNION ALL are identical, leading to redundant computation in Q₈ and Q₉, that system 100 eliminates for Q₁₀.

FIG. 2E depicts a process 200E including a series of blocks for performing a testing and/or verification of a generated output in an example similar to those described with regard to FIGS. 2A-2D. In particular, the exemplary embodiment of FIG. 2E includes a database with two relations, Friendship (e.g., F) and Likes (e.g., L), where F records user friends and L stores user preferred pages. The output is a query that, given a user, returns the recommended pages which their friends prefer but are not preferred by the given user.

Block 210E depicts the database schema S with the two relations: (i) Friendship relation F has two attributes uid and fid, denoting the ID of each user and their friends, and (ii) Likes relation Z with two attributes id and pid, which denote the user ID and the preferred page ID. The integrity constraint C for the task specifies that the pair (uid, fid) is the primary key of F, and id is the primary key of L.

In the exemplary embodiment of FIG. 2E, the block 210E illustrates a user with id=1. Block 210E depicts a query Q₁ that can solve the task for the given user. In particular, Q₁ uses an INNER JOIN operation to find the given user's friends, and uses a nested query followed by a NOT IN filter to rule out the given user's preferred pages. Block 210E further depicts another query Q₂ similar to Q₁, but which uses a LEFT JOIN operation instead. Notably, Q₂≠Q₁. In particular, for a case where the given user does not have any friends (i.e., does not have a tuple with uid=1), the INNER JOIN in Q₁ returns an empty result as the join condition F.uid=1 does not hold, whereas the LEFT JOIN from 2 gives a product tuple t′ for each tuple t in L and t′.pid=NULL. The NULL values on pid will eventually be projected out by Q₂, leading to (incorrect) NULL tuples in the result.

Block 220E shows the symbolic DB generated that has up to 2 rows in each relation (i.e., the input bound is 2). Each row may be referred to as a symbolic tuple. For example, the tuples in F may be denoted by t₁, t₂, and the attribute values may be denoted by x₁=t₁·uid, x₂=t₁·fid, etc. Similarly, the tuples in L are t₃, t₄, and the values for id and pid are y₁, y₂ and y₃, y₄, respectively. In general, the system 100 uses an uninterpreted predicate Del over tuples to indicate whether a tuple is deleted after an operation. Since the value of Del(tᵢ) is unspecified, whether tᵢ is deleted or not is non-deterministic. Thus, the initial symbolic database encodes all databases where each relation has at most two tuples.

Block 230E shows an SMT encoding ϕ_{C} of the integrity constraint C that has two parts. The first part x₁≠Null Λx₂=Null Λx₃≠Null Λx₄=Null Λ¬(x₁=x₃Λx₂=x₄) specifies that tuples t₁, t₂ are unique and all attributes are not null, since (uid, fid) is a primary key. The second part y₁≠Null Λy₃≠Null Λy₁≠y₃ encodes the fact that id is a primary key of relation L.

At block 240E, the system encodes the semantics of a query by encoding the semantics of each operator, which are then composed to form the encoding of the entire query. For example, the formula ϕ₁ to encode Q₁ is the conjunction of ϕ_{R}_{₁}, ϕ_{R}_{₂}, ϕ_{R}_{₃}, and ϕ_{R}_{₄}. Specifically, to encode the inner join T₁ [symbol] T₂ in block 241E, the system 100 considers the Cartesian product of tuples in T₁ and T₂, followed by a filter to set all resulted tuples that do not satisfy T₁·fid=T₂·id and T₁·id=1 as deleted. For the NOT IN in Q₁, the system 100 analyzes the nested query and generates the formula ϕ_{R}_{₂} (as shown at block 242E). The system 100 further checks the membership of T₁·pid with the obtained pid, which is encoded as ϕ₃ in block 243E. Finally, the pid is projected out at block 244E, resulting in the output R₄ and a formula PRA. The obtained formula ϕ₁=ϕ_{R}_{₁}Λϕ_{R}_{₂}Λϕ_{R}_{₃}Λϕ_{R}_{₄} accurately encodes the query semantics of Q₁. Similarly, the output of Q₂ is R₈, and the corresponding formula ϕ₂ consists of ϕ_{R}_{₅}, ϕ_{R}_{₆}, ϕ_{R}_{₇}, and ϕ_{R}_{_{B}} from 245E, 246E, 247E, and 248E, respectively.

At block 250E, after encoding the semantics of queries Q₁ and Q₂, the system 100 compares the outputs R₄ and R₈. Although R₄ and R₈ do not have the same number of symbolic tuples, the outputs can still be equal because some tuples may have been deleted. To check the equality, the system 100 generates a formula de (e.g., depicted in block 250E) asserting R₄ is equal to R₈. The system 100 supports both list and bag semantics. In the exemplary embodiment of FIG. 2E, the system 100 uses bag semantics because neither of the queries involves sorting operations. ϕ_{⇔} encodes two properties: (1) R₄ and R₈ have the same number of non-deleted tuples and (2) for each non-deleted tuple in R₄, the multiplicity of the non-deleted tuple in R₄ is the same as that in R₈.

At block 260E, the system 100 builds a formula ϕ=ϕ_{C}Λϕ₁Λϕ₂Λ¬ϕ_{⇔} encoding the existence of a database D such that (1) D satisfies the integrity constraint C and (2) Q₁ and Q₂ have different outputs on D. The system 100 determines (e.g., via an automatic theorem prover) that ϕ is satisfiable, and thus concludes that Q₁ and Q₂ are not equivalent. The system 100 generates a counterexample database (e.g., at block 260E) where Q₁ and Q₂ yield different results.

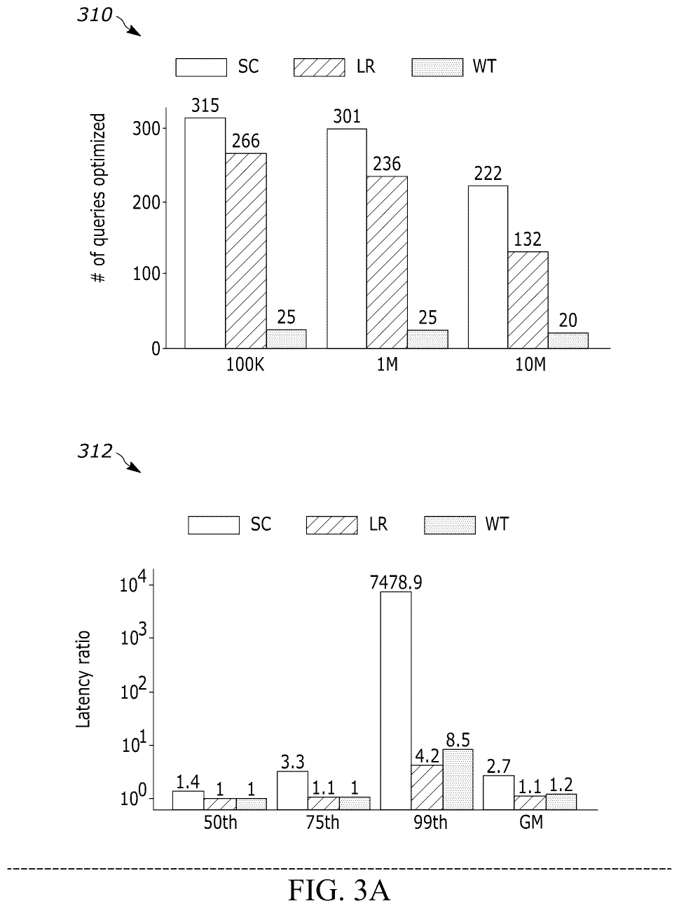

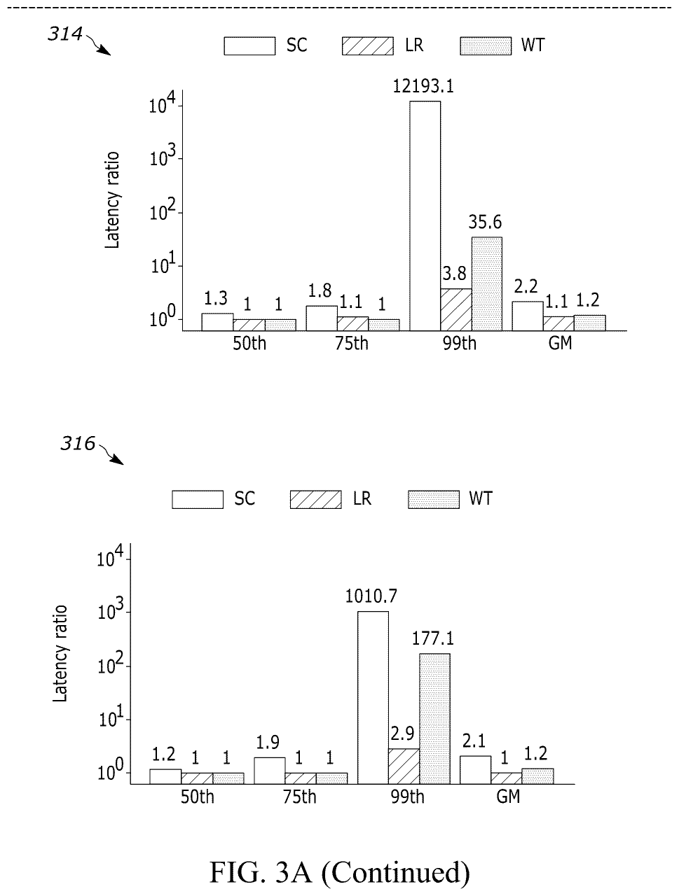

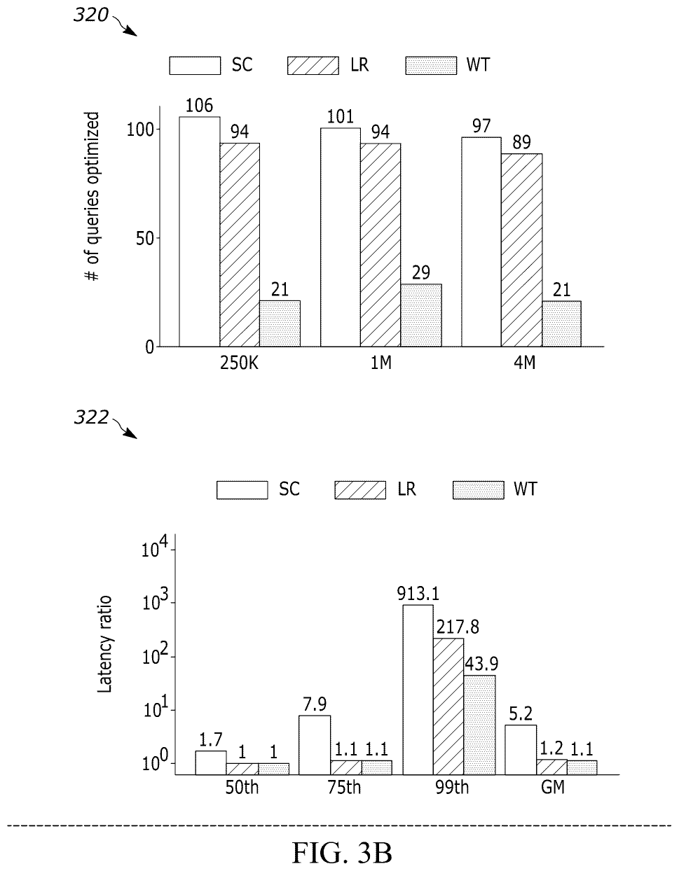

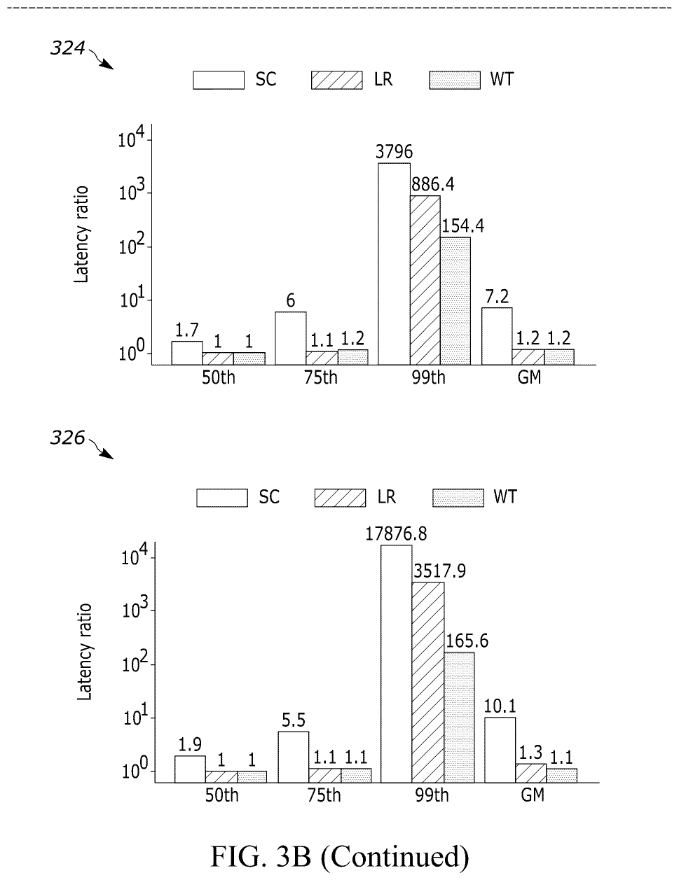

FIGS. 3A and 3B illustrate sets of example bar graphs depicting query coverage and latency reduction for various example database workloads. In particular, FIG. 3A depicts workloads using human-written input queries written and submitted by developers to a public website, and FIG. 3B depicts workloads using rules-based test cases. FIGS. 3A and 3B use databases with randomly generated rows inserted into the tables such that integrity constraints are rigorously maintained. FIG. 3A includes data sizes of 100 thousand, 1 million, and 10 million. FIG. 3B includes data sizes of 250 thousand, 1 million, and 4 million. FIGS. 3A and 3B compare a system (e.g., system 100) running the techniques described herein and two rules-based query rewriters/generators.

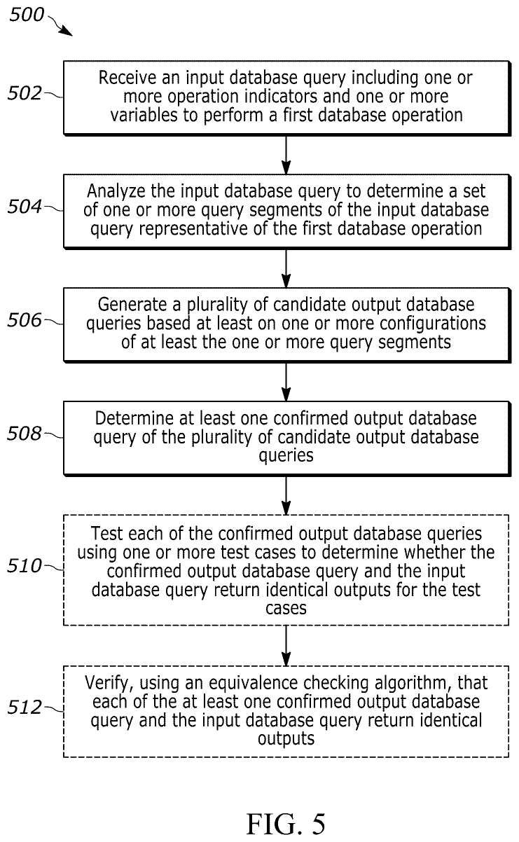

In the exemplary embodiments of FIGS. 3A and 3B, the system 100 runs a method for improving input queries (e.g., as described herein with regard to at least FIGS. 1A, 1B, and 5) for each input query Qᵢₙ to obtain an output query Q. In some implementations, the system 100 runs the method with a timeout period (e.g., a 5 second timeout period). The system 100 determines whether Q improves Qᵢₙ in terms of latency (e.g., if Q has a smaller latency than Qᵢₙ). In some implementations, the system 100 runs each query 3 times and uses the average as the final latency value. In some implementations, output queries that the system 100 does not optimize within a total span of 10 hours are labelled as “not optimized” for the exemplary embodiment of FIGS. 3A and 3B.

As illustrated by graph 310 of FIG. 3A, the system 100 running techniques as described herein improves 315 queries for a database size of 100 thousand, 301 queries for a database size of 1 million, and 222 queries for a database size of 10 million, offering an improvement compared to rules-based techniques (266 and 25 for 100 thousand, 236 and 25 for 1 million, and 132 and 20 for 10 million). Similarly, as illustrated by graph 320 of FIG. 3B, the system 100 running techniques as described herein improves 106 queries for a database size of 250 thousand, 101 queries for a database size of 1 million, and 97 queries for a database size of 4 million, offering a similar improvement compared to rules-based techniques (94 and 21 for 250 thousand, 94 and 29 for 1 million, and 89 and 21 for 4 million).

FIG. 3A further illustrates overall latency reduction for databases of 100 thousand rows (graph 312), 1 million rows (graph 314), and 10 million rows (graph 316), and FIG. 3B illustrates overall latency reduction for databases of 250 thousand rows (graph 322), 1 million rows (graph 324), and 4 million rows (graph 326). Each graph 312-326 depicts a 50^{th} percentile (e.g., a median) value, 75^{th} percentile value, 99^{th} percentile value, and geometric mean value for each of the system 100 implementing techniques as described herein (e.g., SC in FIGS. 3A and 3B) and rules-based techniques (e.g., LR and WT in FIGS. 3A and 3B). The system 100 performing the techniques as described herein outperforms the rules-based techniques for both workloads and all data sizes.

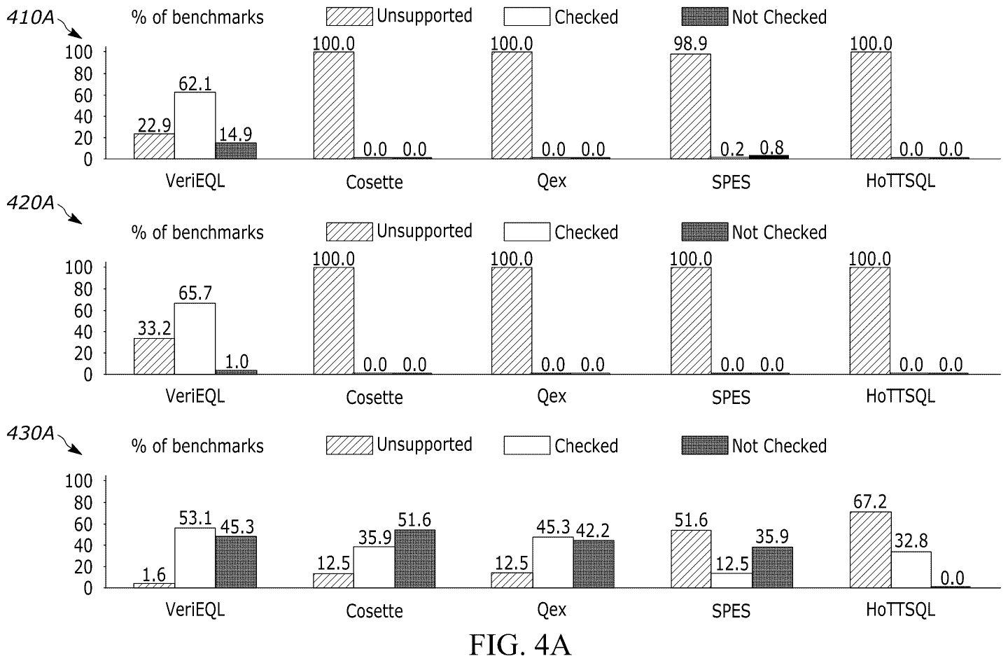

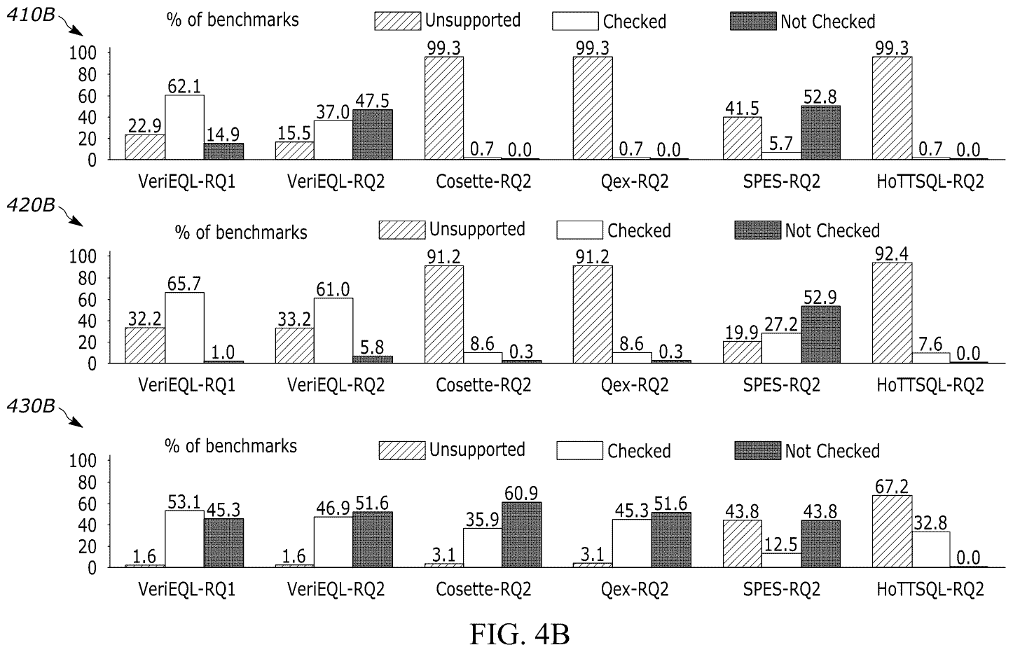

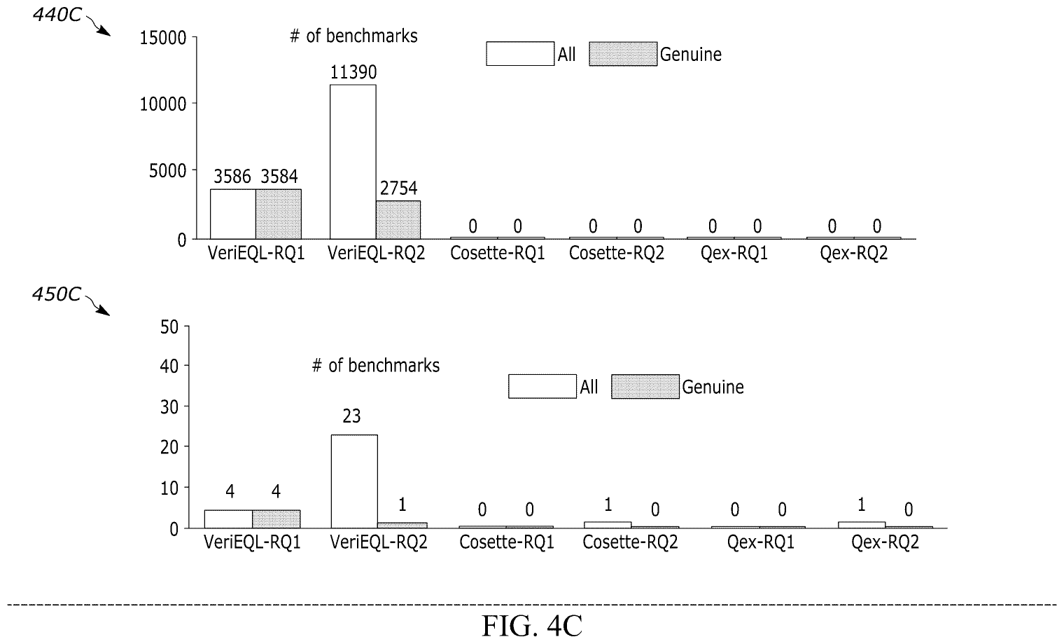

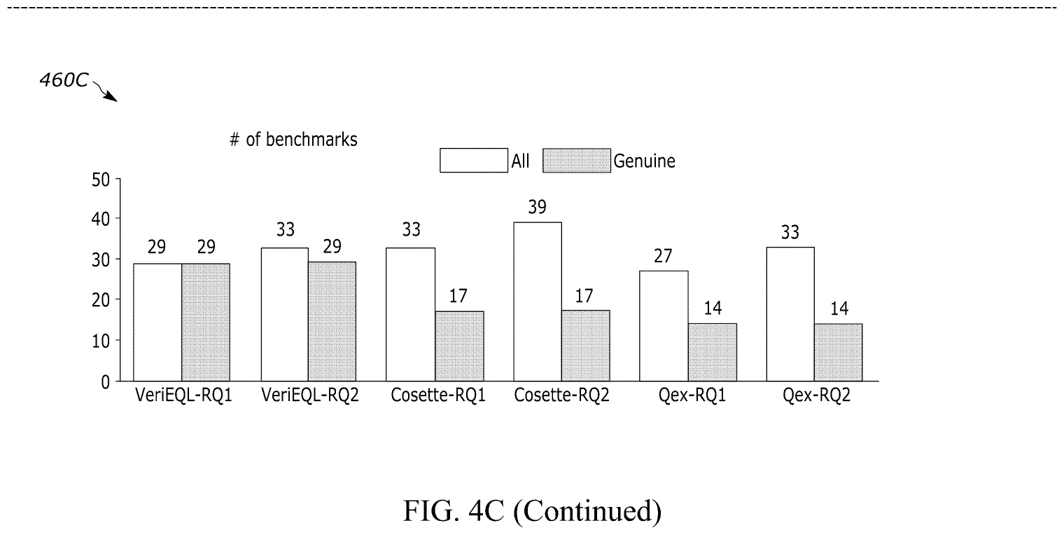

FIGS. 4A-4C illustrate sets of example bar graphs depicting a percentage of benchmarks checked as equivalent for various equivalence checking techniques. In particular, FIGS. 4A-4C may use benchmarks collected from a public site of developer-written query inputs (e.g., LeetCode), a rules-based test suite (e.g., Calcite), and/or from other publicly available test sets of user input queries (e.g., from literature). Further, FIGS. 4A-4C may compare the benchmarks as determined by a system 100 implementing the instant techniques (e.g., referred to herein as VeriEQL) to provenance-base pruning technique (e.g., Cosette and/or Qex) and/or unbounded verification techniques (e.g., SPE and/or HoTTSQL). Depending on the implementation, the system 100 running the instant techniques may mark each benchmark as unsupported, checked, or not checked. A query pair (Q₁, Q₂) is unsupported when the tool in question does not support the query (e.g., not supporting integrity constraints). For a bounded approach, a pair is checked when Q₁ and Q₂ are equivalent against a bounded space and not checked when Q₁ and Q₂ are provably non-equivalent. Similarly, for an unbounded technique, a pair is checked when Q₁ and Q₂ are provably equivalent and not checked when the tool cannot prove equivalence for Q₁ and Q₂ (i.e., equivalence is unknown).

In the exemplary embodiment of FIG. 4A, each of graphs 410A, 420A, and 430A depicts a percentage of benchmarks that are determined to be unsupported, checked, or not checked. As such, in the exemplary embodiment of FIG. 4A, the system 100 and/or an equivalence checker 120 of the system 100 uses the techniques described herein to verify benchmarks consisting of query pairs (Q₁, Q₂) with associated schema and integrity constraint(s). In some implementations, the equivalence checker 120 runs based on a timeout period (e.g., a 10 minute timeout period). In further implementations, the equivalence checker 120 increments a bound from 1 until the timeout is reached or until a counterexample is identified. If the timeout is reached, the equivalence checker 120 reports that the query is checked.

As illustrated in FIG. 4A, the equivalence checker 120 performing the instant techniques supports more than 75% of the benchmarks, whereas baselines support less than 2%. Further, the equivalence checker 120 performing the instant techniques outperforms the baselines across all workloads in terms of both disproving equivalence and proving bounded equivalence of query pairs. Further, as depicted in graph 410A in the exemplary embodiment of FIG. 4A, a system 100 implementing the instant techniques finds that 23% of the developer-written inputs are unsupported and 77% of the developer-written inputs are supported. In the exemplary embodiment of FIG. 4A, other techniques do not support (or provide poor support for) integrity constraints, included in the majority of the developer-written inputs. Further, other developer-written inputs include complex SQL features such as ORDER BY, IN, and/or set operations that some techniques do not support. As such, other techniques support few if any of the developer-written input benchmarks. Graph 420A in the exemplary embodiment of FIG. 4A may cause similar problems for other techniques. Moreover, graph 430A indicates that the system 100 implementing the instant techniques further outperforms other techniques. In the exemplary embodiment of FIG. 4A, the gap between the system 100 implementing the techniques described herein and other techniques in graph 430A is smaller than that of 410A and 420A (e.g., because the queries are better engineered for rules-based and/or other conventional techniques).

Moreover, in graphs 410A and 420A, the system 100 implementing the techniques described herein further outperforms other techniques for checked and not checked benchmarks. Further, the system 100 implementing the techniques described herein compares favorably to other techniques in graph 430A. For example, looking at graph 410A, the system 100 implementing the techniques described herein is able to disprove equivalence for 15% of the benchmarks, whereas none of the bounded baselines disprove any. Similarly, SPES marks 0.8% as not checked, but does not prove non-equivalence.

In the exemplary embodiment of FIG. 4B, each of graphs 410B, 420B, and 430B depicts a percentage of benchmarks that are determined to be unsupported, checked, or not checked, similar to the corresponding graphs (e.g., 410A, 420A, and 430A, respectively) in FIG. 4A, but without considering (e.g., by discarding) integrity constraints. As such, in the exemplary embodiment of FIG. 4B, the system 100 and/or an equivalence checker 120 of the system 100 uses the techniques described herein to verify benchmarks including inputs and/or databases that violate a integrity constraint. Therefore, the unsupported bar is lower, since the system 100 runs the techniques regardless of whether the technique supports the constraint.

Each of graphs 410B, 420B, and 430B depicts the same examples techniques and tools as in FIG. 4A, but including the instant techniques with and without the integrity constraints (i.e., VeriEQL-RQ1 and VeriEQL-RQ2, respectively). For graph 410B benchmarks, comparing the not checked bar increases from 14.9% (RQ1) to 47.5% (RQ2). Notably, more than 75% of the not checked benchmarks in RQ2 are caused by spurious counterexamples. Some of the not checked benchmarks in RQ2 were previously checked in RQ1. For example, the checked bar lowers from 62.1% (RQ1) to 37% (RQ2), whereas the rest were previously unsupported in RQ1. A small number (i.e., 3.3%) of benchmarks previously unsupported in RQ1 now become checked in RQ2, which suggests that discarding integrity constraints does not help prove many more benchmarks. For the other two workloads (e.g., of graphs 420B and 430B), not checked bars increase (e.g., due to spurious counterexamples) and checked bars decrease, indicating that integrity constraints have a noticeable effect on other workloads as well.

For graph 410B, all baselines still have high unsupported percentages, due to limited support of SQL operations. SPES-RQ2 also has a higher not checked bar (e.g., because SPES-RQ2 can now successfully run on 58.5%) but 52.8% are not checked. The trend is consistent: the not checked bar increases. Among the 52.8%, the system 100 implementing the techniques described herein can find valid counterexamples for 26.2%. Graph 420B is similar, where SPES-RQ2 has the highest not checked bar (52.9%). Finally, graph 430B has noticeably higher not checked values.

In the exemplary embodiment of FIG. 4C, each of graphs 440C, 450C, and 460C depicts the ability for the tools and/or techniques to generate counterexamples. In particular, FIG. 4C illustrates, for each bounded approach (including both (i) the system 100 implementing the techniques described herein and (ii) the other baselines), how many benchmarks the tool identifies a counterexample for and how many of the counterexamples are genuine (i.e., not spurious). In the exemplary embodiment of FIG. 4C, a counterexample is genuine if (i) the counterexample meets the integrity constraint associated with the benchmark and (ii) the two queries yield different outputs. Since the unbounded baselines do not produce counterexamples, the system 100 implementing the techniques described herein is compared against the provenance-based pruning techniques (e.g., Cosette and Qex).

According to the exemplary embodiment of FIG. 4C, the system 100 implementing the techniques described herein can prove more non-equivalent benchmarks than all baselines across all workloads. For example, the system 100 implementing the techniques described herein found counterexamples for 3586 developer-written benchmarks (e.g., in graph 440C), 3584 of which are confirmed to be genuine. The counterexample inputs for the remaining two benchmarks conform to the integrity constraints but produce the same output when executed on the input using MySQL (e.g., due to a big in MySQL, as MySQL should produce different outputs). When dropping integrity constraints (e.g., for FIG. 4B), the system 100 implementing the techniques described herein found 11390 counterexamples, but only 2754 are genuine, which suggests that the false alarm rate will be higher without considering constraints. The other two graphs 450C and 460C illustrate similar results.

FIG. 5 illustrates an exemplary method 500 for performing a query search to rewrite input database queries, implemented by a computing system (e.g., system 100). It will be understood that the method 500 may be performed by other systems and/or components thereof (e.g., query synthesizer 110 of FIG. 1A, other systems configured to perform similar operations, and/or components thereof).

At block 502, the system 100 receives an input database query. The input database query may include one or more operation indicators and one or more variables to perform a first database operation within a first period of time. Depending on the implementation, the input database query may be a database query written by a human, automatically generated by a program (e.g., a database search program), received from another computing device, etc. The input database query may be written in a database language (e.g., SQL) and/or through a database frontend (e.g., CLSQL, LINQ, HaskellDB, etc.). In implementations in which the input database query is generated by a program, a user may write a command in another programming language and/or in a human-readable language from which the system 100 generates the input database query.

At block 504, the system 100 analyzes the input database query to determine a set of one or more query segments of the input database query. The query segments may be representative of at least the first database operation. In some implementations, the query segments include one or more dataflows representative of at least one or more operation indicators or the one or more variables. For example, the system 100 may determine one or more operation indicators based on one or more reserved words or symbols for the language (e.g., arithmetic operators (+, −, *, /, %, etc.), comparison operators (=, !=, < >, >, <, >=, <=, !<, !>, etc.), logical operators (ALL, AND, ANY BETWEEN, EXISTS, IN, LIKE, NOT, OR, IS NULL, SOME, UNIQUE, etc.), and/or any other such reserved words or symbols). As such, in some implementations, the dataflow(s) are representative of how the computation would be performed by the input database query.

Further, the system 100 may similarly determine one or more variables based on one or more reserved words or symbols (e.g., int, char, string, etc.) and/or by detecting one or more words that are not reserved words. For example, the system 100 may detect that a variable “num” is a variable because the system 100 detects “int” immediately preceding it. Depending on the implementation, the system 100 may utilize various semantic analysis techniques to determine and/or detect the query segments.

Due to the system 100 using query segment analysis rather than rules-based analysis, the system 100 is able to improve a wider range of input queries than traditional techniques using fewer resources and/or in less time, as described with regard to FIGS. 3A and 3B. For example, conventional techniques that rely on rules-based methodologies are limited in that the conventional techniques are unable to improve any input query that is not covered by a pre-defined set of rules. Moreover, to create a comprehensive set of rules requires large quantities of human and computing resources as well as time. The instant techniques allow the system 100 to avoid the initial investment of resources needed for rules-based techniques.

At block 506, the system 100 generates a plurality of candidate output database queries. The candidate output database queries are based at least on one or more configurations of the query segments. As such, the system 100 generates the candidate output database queries rather than taking a conventional transformational approach (e.g., ‘searching’ for an output query in the language by segmenting, generating, and evaluating various possible ways to compose the query rather than transforming the input to the output according to pre-defined rules). Moreover, by analyzing the input database query to determine query segments and generating candidate output database queries based on such, the techniques described herein allow for an improved process over other search-based techniques by decreasing the time needed to determine candidate output database queries (e.g., in that the techniques described herein do not necessarily consider every possible query and instead more efficiently search based on the composed query segments).

At block 508, the system 100 determines at least one confirmed output database query of the plurality of candidate output database queries. In some implementations, the confirmed output database query, when implemented by a computing device, causes the computing device to perform a second database operation equivalent to the first database operation. In further implementations, the computing device performs the second database operation within a second period of time shorter than or equal to the first period of time.

In some implementations in which the query segment(s) include dataflows representative of the operation indicators and/or variables in the original input database query, the system 100 determines the confirmed output database query by calculating scores for the candidate output database queries. In particular, the system 100 analyzes each candidate output database query to calculate a score for each candidate output database query. The system 100 then orders the plurality of candidate output database queries based on the score for each candidate output database query. The system 100 may then analyze, in accordance with the ordering, at least some of the plurality of candidate output database queries to determine at least one confirmed output database query.

In some implementations, the score for each candidate output database query is based at least on a number of shared dataflows between the input database query and the corresponding candidate output database query. In further implementations, the ordering is in order from lowest to highest of computational cost in analyzing the plurality of candidates. In still further implementations, analyzing the plurality of candidate output database queries occurs within a user-defined time period. For example, a user may define that system 100 has 5 seconds, 10 seconds, 30 seconds, etc. to analyze the ordered list of candidate output database queries. After the time period ends, the system 100 stops analyzing the ordered list.

In some implementations, the system 100 uses the dataflow(s) to guide the system 100 in better generating an output query. In particular, search techniques for generating candidate output queries may first cause the system 100 to sort potential output queries and evaluate each in turn (e.g., until a timeout occurs). By ordering based on included dataflows and/or dataflow score (e.g., according to the fewest missing or additional dataflows to most, as described with regard to FIG. 1A above), the system 100 places the output database queries most likely to be an improvement toward the front, increasing the speed at which the system 100 generates an improved output database query.

In some implementations, the system 100 returns a determined candidate output query to the user based on a determined execution speed, resource usage, and/or other such metric for the output database query. In some such implementations, the system 100 evaluates each tested and/or verified output candidate query (e.g., as detailed below) to determine which query to return to a user. In alternate implementations, the system 100 provides the determined candidate output query to another system and/or component to be executed and/or stored rather than returning to a user.

At block 510, the system 100 may test each of the confirmed output database queries determined at block 508. The system 100 may use one or more test cases to determine whether the respective confirmed output database query and the input database query return identical outputs for the test cases. In some implementations, testing a first set of the confirmed output database queries may occur in parallel with determining a second set of confirmed output database queries. In further such implementations, the system 100 determines a third set of confirmed output database queries using results gathered by testing the first set of the confirmed output database queries.

At block 512, the system 100 may verify, using an equivalence checking algorithm, that each of the at least one confirmed output database query and the input database query return identical outputs. In some implementations, verifying may include encoding semantics associated with the one or more operation indicators (e.g., semantics associated with the dataflows) for each of the confirmed output database queries and the input database query. In some such implementations, the verifying may be based at least on the encoded semantics. In further implementations, the verifying is bounded verification (e.g., for inputs up to a predetermined size) rather than unbounded verification (e.g., for all possible inputs) as described herein.

In some implementations, the system 100 performs both testing and verification as described above, as the two may be complementary (e.g., testing is relatively cheap but does not prove equivalence, whereas verification provides an equivalence guarantee but is more expensive).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) such as system 100 of FIGS. 1A and 1B or one or more hardware modules of a computer system (e.g., a processor or a group of processors) such as system 100 may be configured by software (e.g., an application or application portion) as a hardware module that operates to perform certain operations as described herein. Similarly, the computer systems or hardware modules of the computer systems may be configured to execute stored instructions on a memory as described herein to perform operations such as generating and/or analyzing input queries (e.g., as depicted with regard to FIGS. 2A-2E); analyze query efficiency (e.g., as depicted with regard to FIGS. 3A-4C); automatically determine an improved input query (e.g., as depicted with regard to FIG. 5); and/or perform any other such operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connects the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of the example methods described herein may be performed, at least partially, by one or more processors that are temporarily configured (e.g., by software) or that are permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or by processor-implemented hardware modules. The performance of certain of the operations may be distributed among the one or more processors, not only residing within a single machine (having different processing abilities), but also deployed across a number of machines. In some example embodiments, the processors may be located in a single location (e.g., deployed in the field, in an office environment, or as part of a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes on a GPU thread that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as an example only and does not describe every possible embodiment, as describing every possible embodiment would be impractical, if not impossible. One could implement numerous alternate embodiments, using either current technology or technology developed after the filing date of this application.

What is claimed:

1. A computer-implemented method for performing a query search to rewrite queries, the computer-implemented method comprising:
receiving, by one or more processors, an input database query to perform a first database operation, wherein the first database operation occurs within a first period of time;
analyzing, by the one or more processors, the input database query to determine a set of one or more query segments of the input database query representative of the first database operation;
generating, by the one or more processors, a plurality of candidate output database queries based at least on the one or more query segments; and
determining, by the one or more processors, at least one confirmed output database query of the plurality of candidate output database queries, wherein the at least one confirmed output database query, when implemented by a computing device, causes the computing device to perform a second database operation equivalent to the first database operation within a second period of time shorter than or equal to the first period of time.

2. The computer-implemented method of claim 1, wherein the one or more query segments include one or more semantic properties representative of at least one or more operation indicators in the input database query or one or more variables in the input database query.

3. The computer-implemented method of claim 2, wherein determining the at least one confirmed output database query includes:
analyzing, by the one or more processors, at least some of the plurality of candidate output database queries to calculate a score for each analyzed candidate output database query;
generating, by the one or more processors, an ordered list of the plurality of candidate output database queries based on the score for each analyzed candidate output database query; and
analyzing, by the one or more processors and in accordance with the ordering, one or more of the plurality of candidate output database queries to determine the at least one confirmed output database query.

4. The computer-implemented method of claim 3, wherein the score for each analyzed candidate output database query is based at least on a number of shared semantic properties between the input database query and the corresponding candidate output database query.

5. The computer-implemented method of claim 3, wherein the ordered list is in order of computational cost in analyzing the at least some of the plurality of candidates.

6. The computer-implemented method of claim 3, wherein the analyzing the one or more of the plurality of candidate output database queries occurs within a user-defined time period.

7. The computer-implemented method of claim 1, further comprising:
testing, by the one or more processors, each of the at least one confirmed output database query using one or more test cases to determine whether the at least one confirmed output database query and the input database query return identical outputs for the one or more test cases.

8. The computer-implemented method of claim 7, wherein testing a first set of the at least one confirmed output database query occurs in parallel with determining a second set of the at least one confirmed output database query.

9. The computer-implemented method of claim 8, further comprising:
determining, by the one or more processors, a third set of the at least one confirmed output database query using results of testing the first set of the at least one confirmed output database query.

10. The computer-implemented method of claim 7, further comprising:
mutating, by the one or more processors and using a predefined set of mutation rules, the input database query to generate at least one mutant database query; and
generating, by the one or more processors, the one or more test cases including at least one test input for each mutant database query of the at least one mutant database query such that a mutant output for the corresponding mutant database query differs from an output of the input database query.

11. The computer-implemented method of claim 1, further comprising:
verifying, by the one or more processors and using an equivalence checking algorithm, that each of the at least one confirmed output database query and the input database query return identical outputs.

12. The computer-implemented method of claim 11, wherein the verifying includes:
encoding, by the one or more processors, semantics associated with one or more operation indicators in the input database query for each of the at least one confirmed output database query and the input database query; and
wherein the verifying is based at least on the encoded semantics for each of the at least one confirmed output database query and the input database query.

13. A system for performing a query search to rewrite queries, the system comprising:
one or more processors; and
a memory associated with the one or more processors and storing instructions that, when executed, cause the one or more processors to:
receive an input database query to perform a first database operation, wherein the first database operation occurs within a first period of time;
analyze the database query to determine a set of one or more query segments of the input database query representative of the first database operation;
generate a plurality of candidate output database queries based at least on the one or more query segments; and
determine at least one confirmed output database query of the plurality of candidate output database queries, wherein the at least one confirmed output database query, when implemented by a computing device, causes the computing device to perform a second database operation equivalent to the first database operation within a second period of time shorter than or equal to the first period of time.

14. The system of claim 13, wherein the one or more query segments include one or more semantic properties representative of at least one or more operation indicators in the input database query or one or more variables in the input database query.

15. The system of claim 14, wherein determining the at least one confirmed output database query includes:
analyzing at least some of the plurality of candidate output database queries to calculate a score for each analyzed candidate output database query;
generating an ordered list of the plurality of candidate output database queries based on the score for each analyzed candidate output database query; and
analyzing, in accordance with the ordering, one or more of the plurality of candidate output database queries to determine the at least one confirmed output database query.

16. The system of claim 15, wherein the score for each analyzed candidate output database query is based at least on a number of shared semantic properties between the input database query and the corresponding candidate output database query.

17. The system of claim 15, wherein the ordered list is in order of computational cost in analyzing the at least some of the plurality of candidates.

18. The system of claim 15, wherein the analyzing the one or more of the plurality of candidate output database queries occurs within a user-defined time period.

19. The system of claim 13, wherein the memory further includes instructions that, when executed, cause the one or more processors to:
test each of the at least one confirmed output database query using one or more test cases to determine whether the at least one confirmed output database query and the input database query return identical outputs for the one or more test cases.

20. The system of claim 19, wherein testing a first set of the at least one confirmed output database query occurs in parallel with determining a second set of the at least one confirmed output database query.

21. The system of claim 20, wherein the memory further includes instructions that, when executed, cause the one or more processors to:
determine a third set of the at least one confirmed output database query using results of testing the first set of the at least one confirmed output database query.

22. The system of claim 13, wherein the memory further includes instructions that, when executed, cause the one or more processors to:
mutate, using a predefined set of mutation rules, the input database query to generate at least one mutant database query; and
generate the one or more test cases including at least one test input for each mutant database query of the at least one mutant database query such that a mutant output for the corresponding mutant database query differs from an output of the input database query.

23. The system of claim 13, wherein the memory further includes instructions that, when executed, cause the one or more processors to:
verify, using an equivalence checking algorithm, that each of the at least one confirmed output database query and the input database query return identical outputs.

24. The system of claim 23, wherein the verifying includes:
encoding semantics associated with one or more operation indicators in the input database query for each of the at least one confirmed output database query and the input database query; and
wherein the verifying is based at least on the encoded semantics for each of the at least one confirmed output database query and the input database query.
